(19) United States
(12) Patent Application Publication
(10) Pub. No.: US 2025/0316984 A1
(43) Pub. Date: Oct. 9, 2025

(54) RESILIENT DISTRIBUTED MICROGRID CONTROL

(71) Applicant: THE RESEARCH FOUNDATION FOR THE STATE UNIVERSITY OF NEW YORK, Albany, NY (US)

(72) Inventors: Peng ZHANG, Storrs, CT (US); Pouya BABAHAJIANI, Stony Brook, NY (US)

(73) Assignee: THE RESEARCH FOUNDATION FOR THE STATE UNIVERSITY OF NEW YORK, Albany, NY (US)

(21) Appl. No.: 18/866,861

(22) PCT Filed: May 17, 2023
(86) PCT No.: PCT/US2023/022457

§ 371 Date: Nov. 18, 2024

Related U.S. Application Data
(60) Provisional application No. 63/343,394, filed on May 18, 2022.

(51) Int. Cl. H02J 3/40; G06N 10/60; H02J 1/10; H02J 3/38; H02J 3/46

(52) U.S. Cl. CPC H02J 3/40; G06N 10/60; H02J 1/106; H02J 3/381; H02J 3/46; H02J 2300/24; H02J 2300/28

(57) ABSTRACT

A quantum-distributed microgrid controller employing a synchronization mechanism by leveraging the quantum properties of qubits. Since the distributed control problems of electrical networks such as microgrids can be modeled as networked differential equations, a proposed master equation is leveraged to construct the network of differential equations. By characterizing proper observables, expectation values of all the observers at all nodes will eventually get synchronized to a possibly time-varying target value and the synchronization rule follows the forced Kuramoto model. The quantum synchronization scheme is exploited to regulate AC microgrids' frequency and DC microgrids' voltage and guarantee precise power sharing. Due to the superposition feature of qubits, the QDC provides a foundation for introducing more enhanced quantum-secure distributed control for microgrids through randomizing the θ angle of qubits in the initialization step, which finally results in an unprecedented security for distributed control of AC and DC microgrids.

### CROSS REFERENCE TO RELATED APPLICATIONS

This application is a national phase application of International Patent Application No. PCT/US2023/022457 filed on May 17, 2023, which claims the benefit of U.S. Provisional Application No. 63/343,394 filed on May 18, 2022, the entirety of which is incorporated by reference.

### STATEMENT REGARDING FEDERALLY SPONSORED RESEARCH OR DEVELOPMENT

This invention was made with government support under 2018492, 2134840 and 2040599 awarded by National Science Foundation. The government has certain rights in the invention.

### FIELD

The present application relates generally to systems and methods for controlling multi-inverter microgrids, and particularly, quantum computing systems and methods for scalable and secure quantum distributed microgrid control.

### BACKGROUND

Microgrids, featured by the autonomic coordination of their local energy sources and power demands, have proven to be a promising new paradigm of electricity resiliency, and thus their share in the energy sector is swiftly growing. In an AC microgrid, distributed energy resources (DERs) provide electrical power that oscillates as sinusoidal waves. Since these waves are finally superimposed, they need to be synchronized to the same (rated) frequency; otherwise, desynchronization of DERs cause the delivered power to fluctuate, which can lead to equipment malfunction and damages and even power outages. Adding to the challenge is the increase in penetrations resulting from the ongoing integration of energy from DERs that are inherently heterogeneous and may further impair the synchronization. Therefore, maintaining frequency synchronization is challenging since the system is complicated in various ways.

Distributed control of multi-inverter microgrids has attracted considerable attention as it can achieve the combined goals of flexible plug-and-play architecture, guaranteeing frequency and voltage regulation while preserving precise power sharing among nonidentical DERs. In distributed control of microgrids, a sparse communication network can be used which has less computational complexity at each inverter controller. As a result, the infrastructure cost can be reduced and the system scalability can be improved. Furthermore, it provides solutions to problems of single point-of-failure and complicated two-way communication networks of central control schemes, offering more reliability while being resilient to faults or unknown system parameters.

However, security of communication among distant parties is an indispensable criterion for evaluating the performance of any communication network and distributed control of microgrids is not an exception. While distributed control strategies can enhance microgrids resilience, the openness brought by the corresponding communication networks may cause cybersecurity challenges since they can be susceptible to cyber attacks on communication links. Adversarial attacks from third party agents can drive the microgrid toward inconsistent performance and impair the operation and control functions of participating DERs and stability of the whole system.

Finding solutions to encounter cyber manipulation in microgrids with distributed control strategies is an ongoing research. However, the existing solutions may become insecure due to the rapid development of supercomputers and the emergence of quantum computers and so they can make traditional/classical methods obsolete. On the other hand, utilizing principles of quantum mechanics, quantum communication offers provable security of communication and is a promising solution to counter such threats.

Quantum physics principles give rise to novel capability unattainable with classical transmission media. Such a quantum communication enables secure communication between any two points and will connect quantum processors in order to achieve capabilities that are provably impossible by using only classical information. Several major applications have already been reported, including secure communication, quantum distributed computation, simulation of quantum many-body systems and exponential savings in communication. However, central to all these applications is the ability to transmit quantum bits (qubits) which cannot be copied, and any attempt to do so can be detected. This feature makes qubits well suited for security applications.

Regarding this revolutionary step in secure communication, many models including quantum key distribution (QKD), quantum teleportation and quantum secure direct communication have been developed. Based on QKD technology, many different types of quantum communication networks have been proposed. However, these communication networks based on QKD technology only transmit the key, but do not directly transmit information.

### SUMMARY

Accordingly, disclosed are systems, methods and computer program products for a quantum distributed microgrid control that employs interactive qubits.

A system and method for quantum distributed microgrid control employing quantum secure direct communication which is an information carrier with quantum state in communication. In aspects of the invention, secret information is directly transmitted over a secure quantum channel and, in contrast to QKD schemes, they do not require key distribution and key storage.

In one aspect, there is provided a quantum communication infrastructure for distributed control of microgrids that guarantee control objectives like frequency/voltage regulation and power/current sharing in AC and DC microgrids.

According to this aspect, there is provided a scalable quantum distributed controller (QDC) for AC and DC microgrids within which, the information carrier is quantum states and the transmission media is a quantum channel, i.e., information is encoded into quantum states which are directly sent over quantum channels among participating DERs. Quantum states are then processed and measured at each DER and the measurement outcomes are exploited as control signals.

In one aspect, there is provided a system for distributed control of an electrical network, the network having a plurality of distributed energy resource nodes for providing power to a connected load. The system comprises: a quantum processor associated with each distributed energy resource (DER) node, each quantum processor configured to: prepare one or more qubits representing a quantum state associated with the power signals provided to the electrical network by the DER node; receive one or more additional qubits input from one or more adjacent DER nodes, each one or more additional qubit representing a quantum state associated with the power signals provided to the electrical network by each adjacent DER node; iteratively update, over time, a quantum state associated with the DER node by processing the one or more qubits and additional qubits received from adjacent nodes, and measuring, at each iteration, using a measurement device, one or more processed qubits to obtain a corresponding measured phase angle value associated with a state of power signals provided by the DER and the adjacent DER nodes; generate, using a computing device, one or more control signals based on the obtained corresponding measured phase angle value; and use, by the computing device, the control signals to control a characteristic of the power signals provided to the electrical network by the DER node.

According to a further aspect, there is provided a quantum distributed electrical network control system. The system comprises: a plurality of quantum computing nodes, each quantum node associated with a distributed energy resource (DER) producing energy in an electrical network; a quantum processor associated with each quantum node for processing qubits; and a quantum communications infrastructure comprising quantum channels connecting quantum processors at one or more quantum nodes, each quantum channel configured to enable an exchange of qubits between connected quantum processors; wherein each quantum processor at a quantum node is configured to: encode one or more qubits at the quantum node with quantum state information associated with power signals shared in the electrical network by the associated DER; receive, over the quantum channels, one or more qubits from other adjacent quantum nodes sharing power signals in the electrical network by the adjacent DERs, each received one or more qubits from adjacent quantum nodes encoded with quantum state information associated with shared power signals provided to the electrical network by the adjacent DER; configure a quantum circuit at each node to simulate an open quantum system represented by a master equation; process, using the configured quantum circuit at each node, each the encoded one or more qubits at the quantum node and the received one or more encoded qubits from other adjacent quantum nodes, to generate an output signal value representing a phase angle of the quantum state of the quantum node associated with the DER; convert the phase angle value into a control signal; and use the control signal to synchronize the power signals provided to the electrical network by each the DER.

In a further aspect there is provided a method for distributed control of an electrical network, the network having a plurality of distributed energy resource nodes for providing power to a connected load. The method comprises: preparing, using a quantum processor associated with each distributed energy resource (DER) node, one or more qubits representing a quantum state associated with the power signals provided to the electrical network by the DER node; receiving, over a quantum communications channel, one or more additional qubits input from one or more adjacent DER nodes, each one or more additional qubit representing a quantum state associated with the power signals provided to the electrical network by each adjacent DER node; iteratively updating, over time, using the quantum processor, a quantum state associated with the DER node by processing the one or more qubits and additional qubits received from adjacent nodes, and measuring, at each iteration, using a measurement device, one or more processed qubits to obtain a corresponding measured phase angle value associated with a state of power signals provided by the DER and the adjacent DER nodes; generating, using a computing device, one or more control signals based on the obtained corresponding measured phase angle value; and using, by the computing device, the control signals to control a characteristic of the power signals provided to the electrical network by the DER node.

According to a further aspect, there is provided a method for distributed control of an electrical network having a plurality of quantum computing nodes, each quantum node associated with a distributed energy resource (DER) producing energy in an electrical network, each quantum node having an associated quantum processor for processing qubits, and the electrical network having a quantum communications infrastructure comprising quantum channels connecting quantum processors at one or more quantum nodes, each quantum channel configured to enable an exchange of qubits between connected quantum processors. The method comprises: encoding, at a quantum processor at each quantum node, one or more qubits at the quantum node with quantum state information associated with power signals shared in the electrical network by the associated DER; receiving, over the quantum channels, one or more qubits from other adjacent quantum nodes sharing power signals in the electrical network by the adjacent DERs, each the received one or more qubits from adjacent quantum nodes encoded with quantum state information associated with shared power signals provided to the electrical network by the adjacent DER; configuring, by the quantum processor, a quantum circuit at each node to simulate an open quantum system represented by a master equation; processing, using the configured quantum circuit at each node, each the encoded one or more qubits at the quantum node and the received one or more encoded qubits from other adjacent quantum nodes, to generate an output signal value representing a phase angle of the quantum state of the quantum node associated with the DER; converting, using a computer system, the phase angle value into a control signal; and using the control signal to synchronize the power signals provided to the electrical network by each the DER.

In a further aspect, to meet objectives in distributed control and coordination entails driving a network to reach a consensus, where all agents hold the same value for some key parameter(s), by local interactions. In the quantum domain, the quantum state evolution of quantum systems with external inputs (open quantum systems) makes use of a Lindblad equation that can be used to obtain a quantum consensus. That is, a quantum consensus can be obtained through a Lindblad master equation with the Lindblad terms generated by swapping operators among the qubits, giving rise to the dynamical evolution of the quantum network. The swapping operations also introduce an underlying interaction graph for the quantum network, which leads to a distributed structure for the master equation.

In an embodiment, a computer programming product is provided that includes instructions that, when executed by at least one hardware processor, configure the at least one hardware processor to perform one or more of the steps, tasks, and/or functions described herein, and the system and/or platform includes a non-transitory memory storage device storing program instructions; and a hardware processor having circuitry and logic to execute said program instructions, wherein the hardware processor is in communication with said memory storage device and in response to executing said program instructions, is configured to perform the steps, task, and/or functions described herein.

The foregoing and other objects, features, and/or advantages of the invention will be apparent from the following more particular descriptions and exemplary embodiments of the invention as illustrated in the accompanying drawings wherein like reference numbers generally represent like parts of the illustrative embodiments of the invention.

### BRIEF DESCRIPTION OF THE DRAWINGS

FIG. 1 illustrates a scalable quantum distributed controller framework for microgrids via interacting Qubits in an aspect of the disclosure;

FIG. 2 depicts a coupling of the physical microgrid to a network of quantum controllers that can be considered a coupling of Kuramoto models in an embodiment;

FIG. 3 depicts a Qubit state representation on the Block sphere showing a rotation- [symbol] operator including a single-qubit rotation through angle ϕ radians around the Z-axis;

FIG. 4 depicts a quantum-distributed control method for controlling use and distribution of energy produced by microgrids in a quantum-secure manner according to embodiments of the invention;

FIG. 5 conceptually depicts the master equation evolution at a quantum node according to an embodiment;

FIG. 6 illustrates the trajectories of ϕ₁ and ϕ₂, i.e. phase angles of |q₁ [symbol] and |q₂ [symbol] respectively;

FIG. 7 depicts conceptually the centralized scheme for distributed microgrid control of plural DERs of a microgrid;

FIG. 8 is a block diagram illustrating an example computing environment employed at a DER for quantum-secure distributed microgrid control in an embodiment;

FIG. 9 is a more detailed depiction of an embodiment of the quantum distributed control for the case of an AC microgrid network and particularly processing at a DER node i (DERᵢ) implementing primary controller;

FIG. 10 depicts two adjacent DER nodes: first DERᵢ node encoding state information and a second node DERⱼ node encoding state information that exchange qubits for communication over communication channel;

FIG. 11 is a more detailed depiction of an embodiment of the quantum distributed control for the case of an DC microgrid network and particularly processing at a DER node i (DERᵢ) implementing a different primary controller;

FIG. 12A illustrates a schematic depicting and example network of AC microgrids with bidirectional arrows representing the undirected quantum communications according to embodiments herein;

FIG. 12B depicts example values of all networked microgrid parameters used for distributed quantum control of power to satisfy real-time demands in the example network of microgrids of FIG. 12A;

FIG. 13A depicts the maintaining of frequency regulation throughout the step load change at t=10 sec; and FIG. 13B depicts the accurate sharing of active power (nᵢPᵢ) among the heterogeneous distributed generators throughout the entire runtime in the example network of FIG. 12A;

FIGS. 14A and 14B depict the example results of the performance of the QDC under a first microgrid plug and play functionality where several DERs in the example microgrid network of FIG. 12A are switched out of network and then switched back in the network;

FIGS. 15A, 15B depict example results of the frequency regulation and active power sharing performance of the QDC after plug-and-play of microgrids 4-5 in the example microgrid network of FIG. 12A;

FIGS. 16A-16B depict a comparison between QDC and a conventional Distributed Averaging Proportional Integral (DAPI) controller in response to both step load and plug-and-play events in the example microgrid network of FIG. 12A;

FIG. 17A depicts an example DC microgrid according to an example embodiment; and FIG. 17B depicts the parameters used in the QDC control of the example DC microgrid of FIG. 17A;

FIG. 18 depicts example results of the voltage regulation after the step load disturbance in the example DC microgrid of FIG. 17A, where the DERs are regulated to converge to the requested DC link voltage of 200V;

FIG. 19A depicts example results of the current sharing after the step load disturbance in the example DC microgrid of FIG. 17A and FIG. 19B depicts example results of the power sharing after the step load disturbance in the example DC microgrid of FIG. 17A;

FIG. 20 depicts a conceptual flow chart of a method performed at the quantum-seucre distributed controller at each DER node of an example microgrid network;

FIG. 21A depicts a connected interaction graph of a network of three quantum nodes associated with three DERs;

FIG. 21B shows the exponential synchronization of phase angles including the trajectories of ϕ₁, ϕ₂ and ϕ₃ for each respective node that converge to ϕ*;

FIG. 21C depicts the representation of the states of the quantum nodes of the example network on the Bloch sphere along time;

FIG. 21D depicts the measurement outcomes are for x, y and z components that are random values; and

FIG. 22 illustrates a schematic of an example computer or processing system used to provide distributed microgrid control in one embodiment.

### DETAILED DESCRIPTION

The following detailed description of aspects of the disclosure will be made in reference to the accompanying drawings. In this disclosure, explanation about related functions or constructions known in the art are omitted for the sake of clearness in understanding the concept of the disclosure to avoid obscuring the disclosure with unnecessary detail.

Embodiments of the invention described herein provide a system and method for quantum distributed control (QDC) of electrical networks. In the following, an electrical network can include an electrical grid including an interconnection of components for delivering electricity to consumers, including but not limited to: a power grid, a transmission grid, a power distribution grid and a microgrid. For illustrative purposes, the following discussion is directed to QDC of microgrid networks, including direct current (DC) microgrids, alternating current (AC) microgrids and hybrid microgrids grids that can connect to larger power grids however, can disconnect and operate autonomously. The system and method provides a synchronization mechanism by leveraging the quantum properties of qubits. Since the distributed control problems of microgrids can be modeled as networked differential equations over a simple, connected graph, the system and method includes a quantum master equation to construct a network of differential equations. Then, characterizing proper observables, expectation values of all the observers at all nodes are synchronized to a time varying target value and the synchronization rule follows the forced Kuramoto model. The quantum synchronization scheme regulates AC microgrids' frequency and DC microgrids' voltage and guarantee precise power sharing. In this framework, each distributed energy resource (DER) is equipped with or connected to a quantum computing (QC) device, which prepares a quantum state for local measurements and then seeks a consensus among all the QCs in a distributed manner. By employing the architecture of quantum network, security of the protocol is enhanced as quantum bits (qubits) cannot be copied, and any attempt to do so can be detected.

The system and method includes a scalable quantum distributed controller (QDC) to enable controlling networks of microgrids through a network of quantum systems that guarantee synchronization (drive a network of DERs to synchronization), and power sharing among DERs to avoid excessive exhaustion of regulatory capacity of certain DERs.

Furthermore, the system and method includes a quantum synchronization scheme that regulates AC microgrids' frequency and DC microgrids' voltage and guarantee precise power sharing.

In the QDC, in contrast to the classical synchronization schemes, quantum bits are exchanged among the nodes which significantly improve the security of the communication among the nodes since quantum bits (qubits) cannot be copied, and any attempt to do so can be detected. Applications of the system and method include:
1—Regulation of AC microgrids' frequency and DC microgrids' voltage and guarantee precise power sharing to avoid excessive exhaustion of regulatory capacity of certain DERs.
2—In AC microgrids, voltage control is the counterpart of frequency control and essentially, reactive power sharing is very similar to active power sharing. So, the QDC can be generalized to distributed voltage control in AC microgrids.
3—QDC can be utilized for distributed frequency control in AC part and distributed voltage control in DC part of hybrid microgrids such that, with one connected network of quantum nodes, frequency control in the AC part, voltage control in the DC part and power sharing in the whole grid are guaranteed simultaneously.
4—The QDC can be extended to unbalanced communications where the Laplacian matrix is no longer doubly stochastic, enabling a quantum synchronization mechanism which is more robust against link failure.
5—The QDC in conjunction with sparse data transmission and event-triggered methods, promises wide adoptions in those applications where resilient high-speed communication is required and computation burden matters.

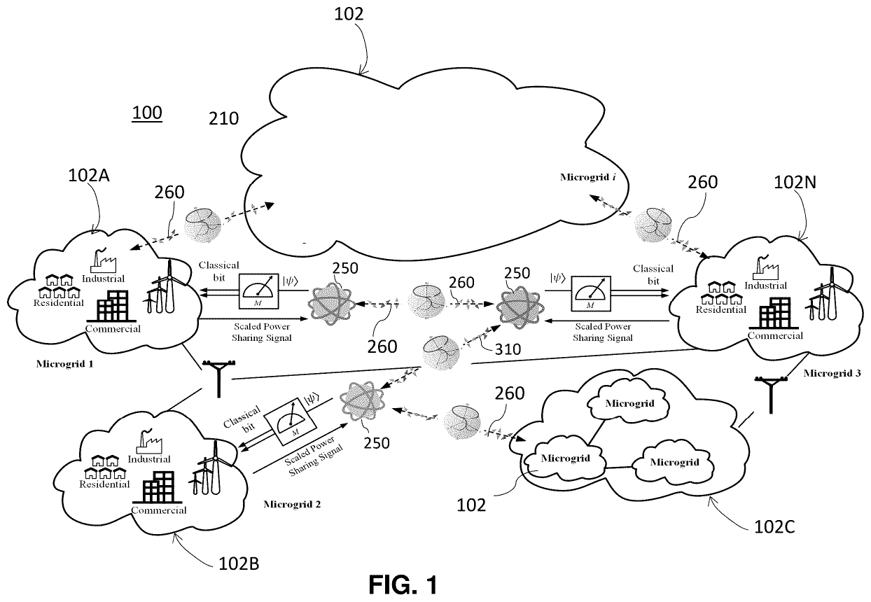

FIG. 1 depicts a scalable quantum distributed controller framework 100 for microgrids via interacting Qubits. In the QDC framework 100, quantum communication is established among the distributed energy resources (DERs).

As shown in FIG. 1, quantum distributed controller network 100 controls an interconnection of quantum-controlled microgrids 102 such as the example interconnection of remotely located microgrids 102A, 102B, . . . , 102N, with each microgrid comprising DERs providing energy (power) for powering different types of loads associated with residential 103, industrial 104, and commercial 105 applications. As shown, one microgrid 102C can itself include an interconnection of microgrids 102.

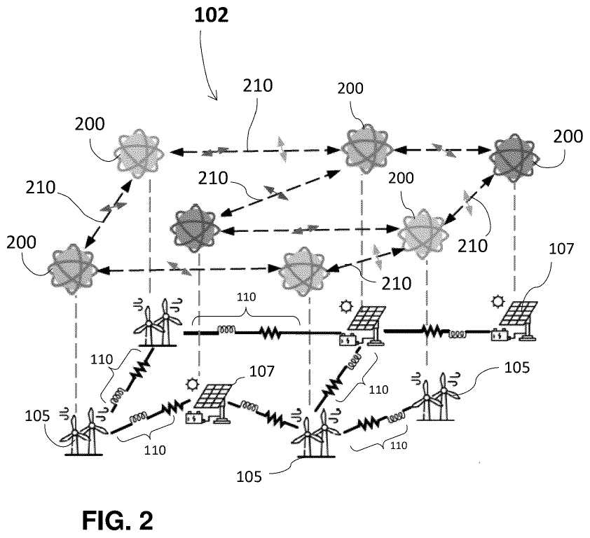

FIG. 2 depicts a coupling of a physical microgrid 102 to the network of quantum controllers. As shown in FIG. 2, the physical microgrid 102 can comprise one or more energy producing resources including, but not limited to: a wind turbine(s) 105 or solar panel(s)/solar generators 107, diesel generators (not shown), etc. As shown in FIG. 2, each of the energy resources 105, 107 are connected together by conductors or conductive links 110 to form an individual microgrid 102 of distributed energy resources (DERs). The conductive links 110 carry alternating current (AC) or direct current (DC) power to a load and can exhibit some impedance (resistance and reactance). For purposes of illustration a microgrid 102 is an AC microgrid. Each energy resource 105, 107 is controlled by a corresponding quantum control system depicted as a quantum controller 200 linked together similarly as the linking of the DERs in the microgrid. Each quantum controller 200 controlling an energy resource within a microgrid is connected to each other over a quantum communications channel 210. Further, as shown in the network 100 of FIG. 1, each respective microgrid 102 (e.g., 102A, 102B, 102C, . . . , 102N) is controlled by a corresponding quantum control system depicted as a quantum controller 250. Each quantum controller 250 controlling a respective microgrid 102 is connected to each other over a quantum communications channel 260. The quantum distributed controlled network of FIG. 2 thus includes a network of quantum processors (not shown) as nodes at specific location that are connected via links. Realization of quantum distributed control requires essential quantum hardware/software elements. A physical link (quantum channel 210) is provided that is able to transmit qubits. Standard telecom fibers are of suitable choices since they are currently used to communicate classical light and so far, photons are known as the ideal physical carrier of information to implement intrinsically secure quantum communications, specifically, for long-distance communications. Various required building blocks for the links such as photonic quantum channels 210 between ground stations or, between ground stations and satellites, quantum repeaters, quantum memory, etc., is provided.

Distributed control problems of microgrids are typically modeled as networked differential equations over a simple, connected graph G=(V, E) that consists of a set of n nodes (or agents), V={v₁, v₂, . . . , vₙ} represents microgrids, and a set of edges, E⊂V×V depicts allowable communication among the microgrids. An edge (vᵢ, vⱼ)⊂E represents that agents vᵢ and nⱼ can exchange information with each other. A sequence of non-repeated edges (vᵢ, vₚ_{₁}), (vₚ_{₁}, vₚ_{₂}), . . . , (vₚ_{ₘ₋₁}, vₚ_{ₘ}), (vₚ_{ₘ}, vⱼ) is called a path between nodes vᵢ and vⱼ. If there exists a path between any two different nodes vᵢ, vⱼ ∈ V, G is said to be connected. An agent vⱼ is called a neighbor of agent vᵢ if (vⱼ, vᵢ)⊂E. The set of neighbors of agent vᵢ is denoted as Nᵢ={vⱼ ∈ V|(vⱼ, vᵢ)⊂E}. The adjacency matrix of graph G, denoted as A, is an n×n matrix whose entries a_{i,j} =1 if vⱼ ∈ Nᵢ and a_{i,j} =0 otherwise. The degree matrix D of graph G, denoted as D, is defined as an n×n diagonal matrix whose ith diagonal entry equals the degree of node vᵢ, i.e., Σᵥ_{ⱼ}_{∈N}_{ᵢ} a_{i,j}. The Laplacian matrix of graph G, denoted as L, is defined as D-A. Note that A, D, L are all symmetric. The node-edge incidence matrix B∈ R^{V×E} is defined component-wise as B_{i,j}=1 if edge j enters node i, B_{i,j}=−1 if edge j leaves node i, and B_{i,j}=0 otherwise. For x∈R^{V}, B^{T}x ∈R^{E} is the vector with components xᵢ −xⱼ, with {i, j}∈E. If diag({a_{i,j}}_{{i,j}∈E}) is the diagonal matrix of edge weights, then the Laplacian matrix is given by L=B diag({a_{i,j}}_{{i,j}∈E})B^{T}.

As an illustrative example, the problem of distributed frequency control and power sharing in AC microgrids can be formulated according to equation 1) as follows

$${ω}_{i} = {ω}^{*} - {n}_{i} {P}_{i} + {Φ}_{i} , \qquad ( 1 )$$

$${Φ}_{i} = f ( {Φ}_{i} , {P}_{i} , {Φ}_{j} , j ∈ {N}_{i} ) ,$$

where ωᵢ represents the derivative of the voltage phase angle of DERᵢ (i.e., the frequency at DERᵢ) with respect to time, ω* is a nominal network frequency, Pᵢ is the measured active power injection at DER ᵢ, nᵢ is the gain of the droop coefficient, Nᵢ denotes the set of neighbors of DER ᵢ (i.e., Nᵢ={vⱼ ∈V|(vⱼ, vᵢ)⊂E}), and the dynamics of Φᵢ represents a secondary control, which is a function (ƒ) of its current value, Pᵢ, and Φⱼ's of its neighbors. The goal of the distributed frequency control problem is to ensure that the network frequency will be regulated to the rated value ω* and that active power sharing is guaranteed (i.e., ωᵢ=ω* and nᵢPᵢ=nⱼPⱼ for all i,j). It is worth emphasizing that Eq. (1) has a universal form which can be used, with simple modification, to describe the problem of distributed voltage control and power/current sharing in DC microgrids.

Recent development in quantum algorithms for solving linear/nonlinear/partial differential equations suggests potential efficiency and capability of quantum devices (gates) in solving these class of equations. Therefore, the quantum distributed framework 100 is constructed to control a network of DERs, as shown in FIG. 2. In this framework, each DER 105, 107 is equipped with or connected to a quantum computing (QC) device 200, which prepares a quantum state to be manipulated and measured and then seeks a consensus among all the QCs in a distributed manner

The state of each quantum device 200 can be described by a positive Hermitian density matrix ρ. Since synchronization requires interaction among all quantum devices, each device can be considered as a quantum system and has access to the (quantum) information of its neighbors. The following equation set forth in equation (2) is the Lindblad master equation for describing the dynamics of a system with dissipation:

$$\dot{ρ} ( t ) = - \frac{ι}{ℏ} [ H , ρ ] + {\sum }_{i = 1}^{n} ( {C}_{i} ρ {C}_{i}^{†} - \frac{1}{2} \{ {C}_{i}^{†} {C}_{i} , ρ \} ) , \qquad ( 2 )$$

where H is the effective Hamiltonian as a Hermitian operator over the underlying Hilbert space, [symbol] is the reduced Planck constant, t denotes the imaginary unit (i.e., ι²=−1), and Cᵢ's are jump operators. For more information on Markovian master equations in Lindblad form. In an embodiment, the Lindblad master equation is leveraged in order to construct the network of differential equations, such as those in Eq. (1), in which, in contrast to the classical synchronization, quantum bits are what is exchanged among the nodes. In an embodiment, by utilizing suitable jump operators and observers for each quantum node would lead the average expectation values of all the observers in the corresponding quantum setting to converge to a possibly time-varying target value and the synchronization rule follows the Kuramoto model modified by the presence of a sinusoidal driving.

The following description makes use of quantum systems and notations where the (adjoint) † symbol indicates the transpose-conjugate in matrix representation, and the tensor product symbol ⊗ is the Kronecker product. The mathematical description of a single quantum system starts by considering a complex Hilbert space [symbol] . Dirac's notation is utilized, where |ψ [symbol] denotes an element of [symbol] , called a ket which is represented by a column vector, while [symbol] ψ|=|ψ [symbol] ^{†} is used for its dual, a bra, represented by a row vector, and [symbol] ψ|=|ψ [symbol] ^{†} for the associated inner product. The set of linear operators on [symbol] is denoted by [symbol] ( [symbol] ). The adjoint operator X^{†} ∈ [symbol] ( [symbol] ) of an operator X∈ [symbol] ( [symbol] ) is the unique operator that satisfies (X|ψ [symbol] )^{†}λ= [symbol] ψ|(X^{†}|λ [symbol] ) for all |ψ [symbol] , |ψ [symbol] ∈ [symbol] . The natural inner product in [symbol] ( [symbol] ) is the Hilbert-Schmidt product [symbol] X, Y [symbol] =tr(X^{†}Y), where tr is the usual trace functional which is canonically defined in a finite dimensional setting. The identity operator is denoted by I. Further, [A, B]=AB−BA is the commutator and {A, B}=AB+BA is the anticommutator of A and B.

A quantum bit (qubit), defined as the quantum state of a two-state quantum system, is the smallest unit of information, and it is analogous to a classical bit. The state of a qubit, represented by |ψ [symbol] =α|0 [symbol] +β|1 [symbol] , is a superposition of the two orthogonal basis states |0∞ and |1 [symbol] , where α and β are complex numbers in general, where |α|²+|β|²=1. The notation of a n-qubit state is simplified to: |q₁ [symbol] ⊗ . . . ⊗|qₙ [symbol] ∈ [symbol] ^{⊗n} as |q₁ . . . qₙ [symbol] .

In the case of mixed state, the state of a quantum system is represented by a density operator ρ, which is a self-adjoint positive semi-definite operator with trace one. Moreover, the state |ψ [symbol] ∈ [symbol] with [symbol] ψ|ψ [symbol] =1 in the above is called a pure state, which can also be written in the form of a density matrix ρ=|ψ [symbol] [symbol] ψ|.

What follows is a method for updating quantum states of a node. The state of each quantum node is updated at each time step according to equation (3) as follows:

$$\vert {q}_{i} ( t ) 〉 = ( \begin{matrix}cos \frac{π}{4} \\ {e}^{ι {ϕ}_{i} ( t )} sin \frac{π}{4}\end{matrix} ) , t ∈ \{ 0 , 1 , 2 , … \} , \qquad ( 3 )$$

which is the general state in polar coordinates set on the xy-plane in the Bloch sphere, where ϕᵢ(0)∈(0, π/2) and each ϕᵢ(t), t≥1, is the averaged measurement outcome which can be obtained by simply averaging measurement outcomes of many realizations of a single experiment for node i.

Letting |ψ [symbol] =|q₁q₂ . . . qₙ [symbol] the state of the whole quantum network and ρ=|ψ [symbol] [symbol] ψ|, there is introduced the following master equation:

$$\dot{ρ} ( t ) = {\sum }_{i = 1}^{n} ( {C}_{i} ρ {C}_{i}^{†} - \frac{1}{2} \{ {C}_{i}^{†} {C}_{i} , ρ \} ) + {\sum }_{\{ i , j \} ∈ E} ( {C}_{i} ρ {C}_{i}^{†} - \frac{1}{2} \{ {C}_{i}^{†} {C}_{i} , ρ \} ) \qquad ( 4 )$$

where C_{i,j} is the swapping operator that specifies the external interaction between quantum computing devices i and j such that

$${C}_{i , j} ( \vert {q}_{1} 〉 ⊗ … ⊗ \vert {q}_{i} 〉 ⊗ … ⊗ \vert {q}_{j} 〉 ⊗ … ⊗ \vert {q}_{n} 〉 ) = \vert {q}_{1} 〉 ⊗ … ⊗ \vert {q}_{j} 〉 ⊗ … ⊗ \vert {q}_{i} 〉 ⊗ … ⊗ \vert {q}_{n} 〉 . \qquad ( 5 )$$

where ⊗ denotes the tensor product. The jump operator, Cᵢ, is defined by equation (6) as:

$${C}_{i} = {I}^{⊗ ( i - 1 )} ⊗ {R}_{z} ( ϕ ) ⊗ {I}^{⊗ ( n - i )} \qquad ( 6 )$$

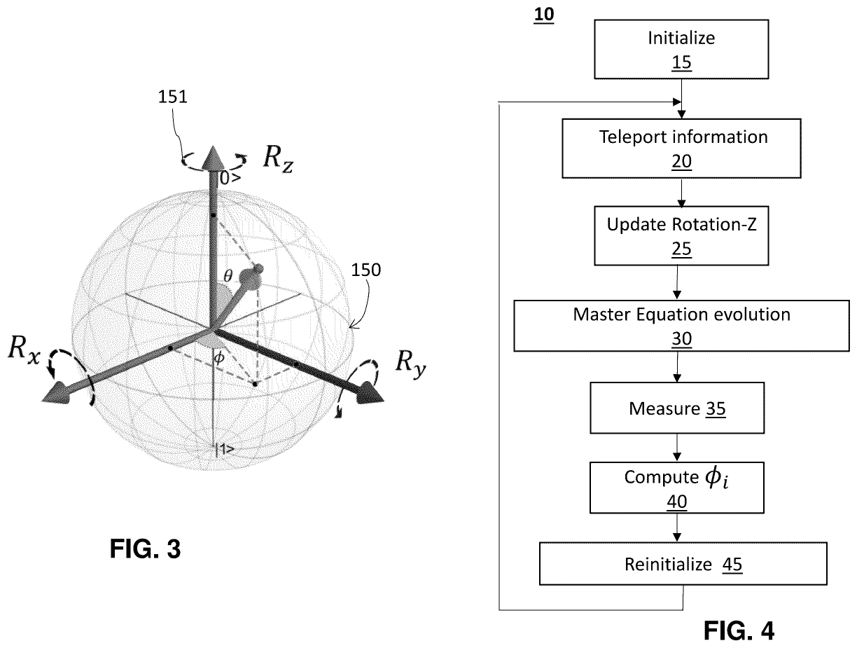

with R_{z}(ϕ) being the rotation-Z operator which is a single-qubit rotation through angle ϕ radians around the Z-axis as shown in FIG. 3 depicting the Qubit state representation on the Bloch sphere 150. In particular, rotations around the positive [symbol] axis is represented by the dashed arrow 151 according to equation 7) as follows:

$${R}_{z} ( ϕ ) = ( \begin{matrix}{e}^{- ι ϕ / 2} & 0 \\ 0 & {e}^{ι ϕ / 2}\end{matrix} ) . \qquad ( 7 )$$

By definition, according to equation (8), the operator Cᵢ acts only on qᵢ without changing the states of other qubits, i.e.,

$$\begin{matrix}{C}_{i} ρ {C}_{i}^{†} = {C}_{i} ( \vert {\overbrace{{q}_{1} …}}^{i - 1} {q}_{i} {\overbrace{… {q}_{n}}}^{n - i} 〉 〈 {\overbrace{{q}_{1} …}}^{i - 1} {q}_{i} {\overbrace{… {q}_{n}}}^{n - i} \vert ) {C}_{i}^{†} \\ = \vert {\overbrace{{q}_{1} …}}^{i - 1} {q}_{i}^{′} {\overbrace{… {q}_{n}}}^{n - i} 〉 〈 {\overbrace{{q}_{1} …}}^{i - 1} {q}_{i}^{′} {\overbrace{… {q}_{n}}}^{n - i} \vert\end{matrix} \qquad ( 8 )$$

To see the impact of the introduced jump operator on qᵢ, by selecting ϕ=ϕ_{t,i} −ϕᵢ there is had an equation (9) as follows:

$$\begin{matrix}{R}_{z} ( ϕ ) \vert {q}_{i} 〉 〈 {q}_{i} \vert {R}_{z}^{†} ( ϕ ) = ( \begin{matrix}{cos}^{2} \frac{π}{4} & {e}^{- ι ( {ϕ}_{1} + ϕ )} cos \frac{π}{4} sin \frac{π}{4} \\ {e}^{ι ( {ϕ}_{i} + ϕ )} cos \frac{π}{4} sin \frac{π}{4} & {sin}^{2} \frac{π}{4}\end{matrix} ) \\ = ( \begin{matrix}cos \frac{π}{4} \\ {e}^{ι ( {ϕ}_{t , i} )} sin \frac{π}{4}\end{matrix} ) ( cos \frac{π}{4} {e}^{- ι ( {ϕ}_{t , i} )} sin \frac{π}{4} )\end{matrix} \qquad ( 9 )$$

which is considered as the target state for quantum node i. As can be seen, the jump operators Cᵢ's are state dependent and updated based on the target values ϕ_{i,t} and the measured ϕᵢ(t). Furthermore, as mentioned, at the beginning of each time step, all the qubits are initialized as (3) based on the measurement outcome of the previous step. Therefore, at each time step, the master equation components are updated based on the target values and the obtained measurement signals. Thus, the density matrix at time t+dt can be decomposed into ρ(t+dt)=ρ(t)+dρₜ, where dρ(t) is defined in (4).

In order to obtain the angles ϕᵢ, there is introduced the following observables according to equations 10) and 11) as follows:

$${A}_{1 , i} = {I}^{⊗ ( i - 1 )} ⊗ {σ}_{x} ⊗ {I}^{⊗ ( n - i )} , \qquad ( 10 )$$

$${A}_{2 , i} = {I}^{⊗ ( i - 1 )} ⊗ {σ}_{y} ⊗ {I}^{⊗ ( n - i )} . \qquad ( 11 )$$

The operator I^{⊗(i-1)} ⊗σ_{x/y} ⊗ I^{⊗(n-i)} acts only on|qᵢ [symbol] where node-wise means, having σₓ and σ_{y} which are Pauli matrices as observables at each node, set forth according to equation 12) as follows:

$${σ}_{x} = ( \begin{matrix}0 & 1 \\ 1 & 0\end{matrix} ) , {σ}_{y} = ( \begin{matrix}0 & - ι \\ ι & 0\end{matrix} ) . \qquad ( 12 )$$

The expectation value of an observable A via measurement on a system described a density matrix ρ is given by [symbol] A [symbol] =tr(ρA). For a general one qubit state ρ, tr(ρσₓ)=rsinθcosϕ, tr(ρσ_{y})=rsinθ sinϕ and tr(ρσ_{z})=rcosθ, where r, θ, an ϕ are the parameters that describe ρ in the Bloch sphere, which is essentially the spherical coordinate but with r≤1. Alternatively, for quantum-secure distributed frequency control, the expectation value of an observable A in a state, represented by a density matrix ρ, tr(ρσ_{z})=r cos θ. Generally, the Lindblad equation results in states becoming more mixed; however, the system is permitted to evolve in a short time and the system is re-initialized in a product of pure qubit states. Therefore, it can be considered that r=1 and θ=π/2 and hence equation 13) results:

$$tr ( ρ {σ}_{x} ) = cos {ϕ}_{i} , tr ( ρ {σ}_{y} ) = sin {ϕ}_{i} . \qquad ( 13 )$$

which are equivalent to tr(ρA_{1,i})=cos ϕᵢ and tr(ρA_{2,i})=sinϕᵢ, respectively. Since both Cᵢ and C_{i,j} are unitary, this results in the relation according to equation 14) as follows:

$$d ρ ( t ) = {\sum }_{i = 1}^{n} ( {C}_{i} ρ {C}_{i}^{†} - ρ ) d t + {\sum }_{\{ i , j \} ∈ E} ( {C}_{i , j} ρ {C}_{i , j}^{†} - ρ ) dt , \qquad ( 14 )$$

If the procedure of the Lindblad evolution is repeated in a short duration, measurement and re-initialization, there can be obtained approximated equations for ϕ's in the limit dt→0. The goal is to obtain the dynamic of the phase angles ϕᵢ. Note that

$$\frac{d}{d t} 〈 A 〉 = \frac{d}{d t} tr ( ρ A ) = t r ( \dot{ρ} A ) .$$

From equation (14) equation 15) results as follows:

$$t r ( \dot{ρ} {A}_{1 , i} ) = cos {ϕ}_{t , i} - cos {ϕ}_{i} + {\sum }_{j = 1}^{n} {a}_{i , j} ( cos {ϕ}_{j} - cos {ϕ}_{i} ) \qquad ( 15 )$$

$$tr ( \dot{ρ} {A}_{2 , i} ) = sin {ϕ}_{t , i} - sin {ϕ}_{i} + {\sum }_{j = 1}^{n} {a}_{i , j} ( sin {ϕ}_{j} - sin {ϕ}_{i} )$$

where a_{i,j} =1 if Cᵢⱼ ≠0 and a_{i,j} =0 otherwise. Utilizing tr(ρA_{1,i}) and tr(ρA_{2,i}), the dynamic of ϕᵢ results according to equation 16) as follows:

$$\begin{matrix}{\dot{ϕ}}_{i} = \frac{d}{d t} arctan ( \frac{t r ( ρ {A}_{2 , i} )}{t r ( ρ {A}_{1 , i} )} ) \\ = \{ \frac{tr ( \dot{ρ} {A}_{2 , i} ) t r ( ρ {A}_{1 , i} ) - tr ( \dot{ρ} {A}_{1 , i} ) t r ( ρ {A}_{2 , i} )}{{cos}^{2} {ϕ}_{i}} \} {cos}^{2} {ϕ}_{i} \\ = sin ( {ϕ}_{t , i} - {ϕ}_{i} ) + {\sum }_{j = 1}^{n} {a}_{i , j} sin ( {ϕ}_{j} - {ϕ}_{i} )\end{matrix} . \qquad ( 16 )$$

In equation 16) both tr(ρA_{1,i}) and tr(ρA_{2,i}) are used to find the trajectory that ϕᵢ traverses along the time; however, either arccos(tr(ρσₓ)) or arcsin(tr(ρσ_{y})) gives ϕᵢ. It can be demonstrated that the pinning term sin(ϕ_{t,i}−ϕᵢ) forces the phase ϕᵢ to stick at the value ϕ_{t,i} and the coupling mechanism

$${\sum }_{j = 1}^{n} {a}_{i , j} sin ( {ϕ}_{j} - {ϕ}_{i} )$$

helps to synchronize the entire system such that, all nodes synchronize to the pinner exponentially fast at a rate no less than μ, with μ being the following:

$$μ = {λ}_{min} ( {σ}_{1} I + {σ}_{2} B W {B}^{T} ) > 0 ,$$

where σ₁=sinc(ϵ), σ₂=sinc(2ϵ), since

$$sin c ( x ) = \frac{sin ( x )}{x} , ε = {max}_{1 \leq i \leq n} \vert {ζ}_{i} \vert ,$$

where ζᵢ denotes the phase deviation of the ith oscillator from the pinner ϕ* (=ϕ_{t,i}), e.g., 0≤ϵ<(π/2), W=diag({a_{i,j}}_{{i,j}∈E}) is the diagonal matrix of edge weights and B=[B_{i,j}]_{n×m} be the incidence matrix of the communication graph G with m being the number of edges. It is noted that BWB^{T} is the Laplacian matrix of the underlying graph G, which is always positive semidefinite. Since σ₁ and σ₂ are positive, σ₁I+σ₂BW B^{T} must be positive definite.

FIG. 4 depicts a quantum-distributed control method 10 for controlling use and distribution of energy produced by microgrids: In particular, a quantum algorithm is required to simulate Eq. (14) at each node (e.g., a quantum processor associated with an energy resource). The overall approach is by first, transforming the open dynamic into Kraus formalism in the operator sum form (if it is in Lindblad representation), which is the most general form of the time evolution for a density matrix, second, converting the Kraus operators into unitary matrices and third, decomposing the unitary matrices into unitary quantum gates. This procedure allows the evolution of the initial state through unitary quantum gates. The third element is measurement. A typical quantum algorithm requires estimated expectation values of a set of operators/observables in a quantum state ρ that can be prepared repeatedly using a programmable quantum system. As discussed, each ϕᵢ(t) is the averaged measurement outcome which is obtained by averaging measurement outcomes of many realizations of a single experiment for node i. The reason is, an informative quantum measurement is demolishing (i.e. causing the wave function to collapse) and gives probabilistic outcomes. Hence, to obtain precise estimates, each operator must be measured many times.

As shown in FIG. 4, the method comprises a first step 15 for initializing qubits as a point on the first quarter of the equator of the Bloch Sphere, i.e., 0<ϕᵢ (0)<π/2 and 0<θᵢ(t)<π, using Eq. (3). In an embodiment, a pair of identical qubits on the first quarter of the Bloch Sphere is initialized. This step is respectively performed to initialize the quantum state of each quantum node. As an illustrative, non-limiting qubit initialization, a quantum node can be represented as

$$\vert {q}_{i} ( 0 ) 〉 = cos \frac{π}{4} \vert 0 〉 + {e}^{{ιϕ}_{i} ( 0 )} sin \frac{π}{4} \vert 1 〉$$

Then, at 20, FIG. 4, there is performed teleporting information throughout the network such that each quantum node receives the quantum information from its adjacent nodes. In an embodiment, quantum information is transmitted through the network such that each quantum node receives a pair of identical qubits from each one of its adjacent nodes. Then, at 25, FIG. 4, at each node, there is performed updating the rotation-Z (R_{z}) operator's argument based on the pinner (ϕ_{t,i}) and the current value of the phase angle ϕᵢ. As a non-limiting illustration of updating the rotation-Z operator's argument, there is computed, for example:

$${R}_{z} ( ϕ ) = ( \begin{matrix}{e}^{- ιϕ / 2} & 0 \\ 0 & {e}^{ιϕ / 2}\end{matrix} )$$

$$ϕ = {ϕ}_{t , i} - {ϕ}_{i}$$

for 1i≤n. Then, at 30, the master equation 14) is evolved for one time step St by means of the swapping and rotation-Z operators. In an embodiment, an exemplary evolution step computes:

$$d ρ ( t ) = {\sum }_{i = 1}^{n} ( {C}_{i} ρ {C}_{i}^{†} - ρ ) dt + {\sum }_{\{ i , j \} ∈ E} ( {C}_{i , j} ρ {C}_{i , j}^{†} - ρ ) d t .$$

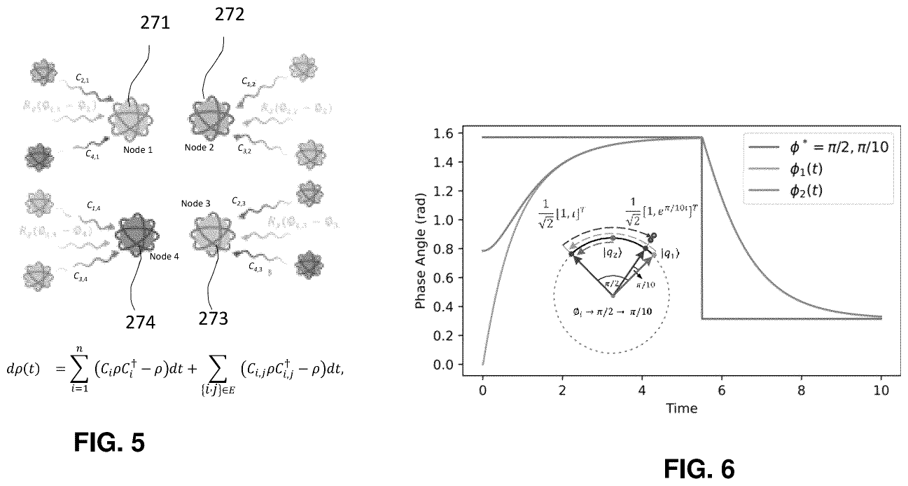

FIG. 5 conceptually depicts the master equation evolution step 30 at a quantum node, e.g., node 1 271, node 2 272, node 3 273, and node 4 274 wherein at first node 271 there is depicted the teleportation of quantum information to node 1 from example adjacent nodes 2 and 4. For example quantum information C_{2,1} from node 2 and information C_{4,1} from node 4 are communicated to node 1 271 which information is used to update the rotation-Z operator (quantum state) at node 1 according to R_{z}(ϕ_{t,1}−ϕ₁). Similarly, quantum information C_{1,2} from node 1 and information C_{3,2} from node 3 are communicated to node 272 which information is used to update the rotation-Z operator at node 2 according to R_{z}(ϕ_{t,2}−ϕ₂). Similarly, quantum information C_{2,3} from node 2 and information C_{4,3} from node 4 are communicated to node 3 273 which information is used to update the rotation-Z operator at node 3 according to R_{z}(ϕ_{t,3}−ϕ₃) and quantum information C_{1,4} from node 1 and information C_{3,4} from node 3 are communicated to node 4 274 which information is used to update the rotation-Z operator at node 4 according to R_{z}(ϕ_{t,4}−ϕ₄) where C_{i,j} is the swapping operator that specifies the external interaction between quantum computing device i and j.

Referring back to FIG. 4, at the next step 35, the node measures the expectation value of the σₓ or σ_{y} operator as the observer at each node. Repeating this multiple times and averaging gives the cos ϕᵢ or sinϕᵢ, depending on the exploited observable. Then, at 40, on classical hardware at each node, the system computes arccos [symbol] ₓ [symbol] or arcsin [symbol] σ_{y} [symbol] to obtain the phase angle ϕᵢ. Then at 45, FIG. 4, the method re-initializes the state of each quantum node according to Eq. (3) and based on the measurement outcomes at step 40. The process 10 returns to step 20 to export the updated information at each quantum controller to the QC of its adjacent nodes and repeats steps 25-45 for multiple iterations (time steps).

For synchronization of the system, it is critical that the pinner for all of the oscillators be the same, i.e., ϕ_{t,i}=ϕ*, otherwise, synchronization cannot be achieved in general. To study whether quantum node i is synchronized to the pinner, it is convenient to study the phase deviation of quantum node i from the pinner. The following change of variables is introduced according to equation 17) as follows:

$${ϕ}_{i} = {ϕ}^{*} + {ζ}_{i} , \qquad ( 17 )$$

where ζᵢ denotes the phase deviation of the ith oscillator from the pinner ϕ*. Substituting (17) into (16), results in the relation depicted in equation (18):

$${\dot{ζ}}_{i} = {\sum }_{j = 1}^{n} {a}_{i , j} sin ( {ζ}_{j} - {ζ}_{i} ) - sin ( {ζ}_{i} ) . \qquad ( 18 )$$

From the properties of equation (18), the condition for synchronization is obtained. If all ζᵢ's converge to 0, then there is ϕᵢ=ϕ* as t→∞, indicating that all nodes are synchronized to the pinner at the exponentially fast rate according to the following equation 19).

$$μ = {λ}_{min} ( {σ}_{1} I + {σ}_{2} B W {B}^{T} ) > 0 , \qquad ( 19 )$$

which implies that all the nodes will synchronize to the pinner exponentially fast at a rate no less than μ, which is dependent on the network connectivity.

### Numerical Example

As an illustrative first example of the quantum system employing qubits for microgrid control, there is considered an example network composed of two quantum nodes with the following initial states:

$$\vert {q}_{1} 〉 = \frac{1}{\sqrt{2}} ( \begin{matrix}1 \\ 1\end{matrix} ) , \vert {q}_{2} 〉 = ( \begin{matrix}1 / \sqrt{2} \\ 0.5 + 0.5 ι\end{matrix} ) .$$

In this first example, the state

$${\frac{1}{\sqrt{2}} [ 1 , ι ]}^{T}$$

is the first target, then at t=5.5 the target changes to the state

$${\frac{1}{\sqrt{2}} [ 1 , {e}^{π / 10 ι} ]}^{T}$$

and hence, the pinner is ϕ*=π/2 and then ϕ*=π/10, respectively. The two qubits |q₁ [symbol] and |q₂ [symbol] interact through a swapping operator, forming a connected interaction graph. The trajectories of ϕ₁ and ϕ₂, i.e. phase angles of |q₁ [symbol] and |q₂ [symbol] respectively, are sketched in FIG. 6 utilizing the Python-based open source software QuTiP (Quantum Toolbox in Python). FIG. 6 in particular depicts Quantum state tracking including the exponential synchronization of phase angles where a selected time step for the numerical example is 10⁻⁴ seconds. As illustrated in FIG. 6, both phase angles converge to ϕᵢ*. Therefore, the final state of the quantum network is |qq [symbol] , where |q [symbol] is denoted by the state

$${\frac{1}{\sqrt{2}} [ 1 , {e}^{π / 10 ι} ]}^{T} .$$

### Quantum Distributed Controller for AC and DC Microgrids

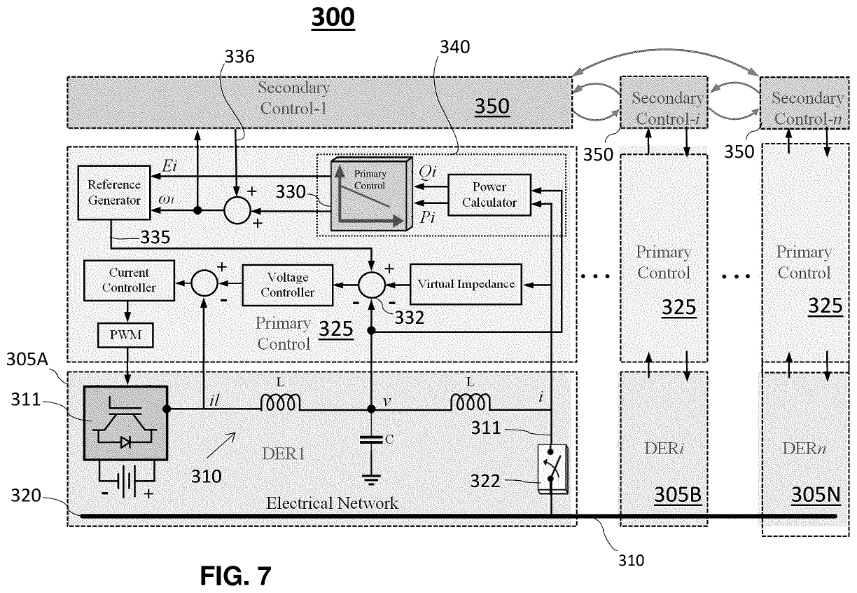

FIG. 7 depicts conceptually the distributed scheme 300 for distributed microgrid control of plural DERs 305A, 305B, . . . , 305N. of an AC microgrid. As shown in FIG. 7, the DER includes both a classical-based primary controller 325 that provides primary control of the DER and a distributed quantum-based controller 350 providing a secondary control [ ]. Each DER 305A is an electrical network 310 having an output conductor carrying output signals 311 that can be switched to connect to a power bus 320 carrying AC power to a network load. In an embodiment, when sharing power with the network, a switch 322 connects the DER output signals 311 to the bus 320 carrying AC power thereby providing a flexible plug-and-play capability. When activated to share (e.g., add) the generated power over the network, switch 322 enables the AC power generated at the DET to be transmitted over the bus 320. As a node in the AC microgrid, DER 305A includes circuitry at the primary controller 325 for automatically controlling the power levels and frequency of the AC power generated at the DER for precise sharing over a microgrid network in response to changes in network loads.

In particular, the primary controller 325 implements various circuits to stabilize system frequency and voltage in the generation of any required additional power. At the DER 305A, the electrical circuitry 310 includes voltage source converter (VSC) 311 or like inverter for generating AC power 311 that are conducted through LCL (filter) circuitry to output signals 311. Primary controller 325 monitors AC power output voltage V and output current i components which are received at power calculator, virtual impedance, reference generator, and voltage controller and current controller circuits used to monitor the voltage V and current i output signal components generated at the DER and regulate the power and frequency, e.g., perform droop control, in accordance with programmable power and frequency set point as controlled by primary controller 330 and secondary controller 350. The virtual impedance multiplies the output current i with an appropriate impedance (resistance and reactance) to result in a voltage or control signal output that is used to alter the control of the VSC 311 to precisely change a power/frequency requirement of the output AC voltage signals.

The voltage output of the virtual impedance circuit that is used to alter the control of the VSC 311 can be further scaled at summation circuit 328 by the output signal generated by a reference generator which generates reference voltage signals based on computed real power Pᵢ and reactive power Qᵢ values responsive to the received voltage V and current i output signal components.

Further reference signals including a nodal voltage Value Ei and a reference frequency ωᵢ are generated at further primary controller circuitry 330 responsive to the obtained real power Pᵢ and reactive power Qᵢ values used in droop control 340. For example, these components are used to regulate the DER's frequency ωᵢ through local measurement of the active power injection at DER ᵢ The nodal voltage Value Eᵢ and a reference frequency ωᵢ are received at the reference generator that in response, generates an appropriate control signal 335 used to further modify the control of the VSC 311 at summation circuit 332. The generated voltage output of summation circuit 332 that is used to alter the control of the VSC 311 is input to a voltage controller circuit that provides an output received at a current controller circuit for generating a reference signal input to a pulse width modulator (PWM) circuit that is used to precisely control the power level and frequency of the AC voltage signals generated at the VSC 311.

The secondary controller 350 implements quantum and classical computing to offset the deviations of frequency/voltage derived from the primary control, and functions to recover the voltage/frequency to the rated steady-state values, e.g., 50 Hz or 60 Hz, when sharing power with other DERs over the networked microgrid. In an embodiment, the secondary controller 350 at DER 305A is implemented as a quantum controller (QC) including quantum processor and associated quantum computing circuitry that is adapted to exchange qubits with neighboring DERs over quantum channels. Each QC at the DER implements a quantum algorithm upon qubits for generating control signals used to provide secondary control for regulating power and frequency of signals generated at the quantum node (DER). In accordance with the method of FIG. 4, the quantum algorithm uses the master equation (Lindblad) equation defining a continuous-time quantum state evolution and functions as a quantum synchronization protocol for distributed control of microgrids by exchanging quantum bits. This is implemented by quantum circuitry at each DER node that generates the secondary control variable ϕᵢ/k 336. In embodiments, the dynamic of Øᵢ shown in equation (16) is the exploitable synchronization protocol for the control objectives and is updated in successive time steps in accordance with the method of FIG. 4 to compute frequency ωᵢ used for controlling the DER node output.

### Quantum-Secure Distributed Control

By implementing some modifications and relaxing the assumption of (re-)initializing qubits on the equator of Bloch sphere, the security of the algorithm can be significantly enhanced such that even if a third party agent can measure the exchanged qubits, the measurement outcomes would be some random values which do not reveal information to the eavesdropper. Furthermore, even if the states become mixed after the master equation evolution, or the (re-)initialization produces mixed states, the synchronization rule remains valid.

In a further embodiment, the state of each quantum node at each time step is prepared according to equation 20) as follows:

$$\begin{matrix}a . & \\ \vert {q}_{i} ( t ) = cos \frac{{θ}_{i} ( t )}{2} \vert 0 + {e}^{{ιϕ}_{i} ( t )} sin \frac{{θ}_{i} ( t )}{2} \vert 1 , t ∈ \{ 0 , 1 , 2 , ... \} , & ( 20 )\end{matrix}$$

which is the general state in polar coordinates set on the surface of the Bloch sphere, where 0<θᵢ(t)<π is a random value and ϕᵢ(0) ∈(0, π/2), and each ϕᵢ(t), t≥1, is the averaged measurement outcome at node i.

Given the master equation (4) where Cᵢ and C_{i,j} are unitary jump operators, in the quantum-secure scheme, the state of each quantum node i at each time step is updated according to equation 21) as follows:

$$\begin{matrix}a . & \\ \vert {q}_{i} ( t ) = cos \frac{π}{4} \vert 0 + {e}^{{ιϕ}_{i} ( t )} sin \frac{π}{4} \vert 1 , t ∈ \{ 0 , 1 , 2 , ... \} , & ( 21 )\end{matrix}$$

which is the general state in polar coordinates set on the xy-plane, where ϕᵢ(0) ∈(0, π/2) and each ϕᵢ(t), t≥1, is inferred from the averaged measurement outcome at node i. Letting each ϕᵢ(t), t≥1, be the averaged measurement outcome at node i, and utilizing the observables (10) and (11), such that

$${ϕ}_{i} = arctan ( \frac{tr ( ρ {A}_{2 , i} )}{tr ( ρ {A}_{1 , i} )} ,$$

and obtaining the following expectation values according to equation 22):

$$\begin{matrix}a . & \\ \begin{matrix}tr ( ρ {A}_{1 , i} ) = {r}_{i} sin {θ}_{i} cos {ϕ}_{i} , \\ tr ( ρ {A}_{2 , i} ) = {r}_{i} sin {θ}_{i} sin {ϕ}_{i} .\end{matrix} , & ( 22 )\end{matrix}$$

where rᵢ, θᵢ, and θᵢ are the parameters describing ρ on the Bloch sphere. There is generated, for providing secondary control at the DER node the following:
   i. A modified dynamic of ϕᵢ according to equation 23) as follows:

$$\begin{matrix}b . & \\ {\dot{ϕ}}_{i} = sin ( {ϕ}_{t , i} - {ϕ}_{i} ) + {\sum }_{j = 1}^{n} {a}_{i , j}^{′} sin ( {ϕ}_{j} - {ϕ}_{i} ) , & ( 23 )\end{matrix}$$

where

$${a}_{i , j}^{′} = {a}_{i , j} \frac{{r}_{j} sin {θ}_{j}}{{r}_{i} sin {θ}_{i}} > 0 if {C}_{ij} \neq 0 and {a}_{i , j}^{′} = 0$$

otherwise.
a. 2. The synchronization rule in 1) remains valid even if the (re-)initialization produces mixed states, or states become mixed after master equation evolution;
b. 3. The random angle θᵢ randomizes the state and hence on average (over θᵢ) the state appears to be random to a third party who measures the exchanged qubits among the quantum nodes.

For quantum-secure distributed control, the additional random angle θᵢ randomizes the state and hence on average (over θᵢ) the state appears to be random, i.e., maximally mixed I/2. Then, the eavesdropper cannot figure out the correct 0/1 basis and consequently, the information is being encoded into θᵢ. Generating the modified dynamic of θᵢ operates even if the (re-) initialization produces mixed states, or states become mixed along the master equation evolution.

Even if the phase ϕᵢ does not change, changing θᵢ impacts the expectation values tr(ρA_{1,i}) and tr(ρA_{2,i}). Therefore, as shown in (16), both tr(ρA_{1,i}) and tr(ρA_{2,i}) are required to find the trajectory traversed by ϕᵢ along the time. However, measuring a qubit results in demolishing that quantum state. Hence, to obtain the both expectations at each node, at each time step, two identical qubits will be prepared according to equation 20) which will experience the same Master equation evolution. Afterwards, expectation value of σₓ is measured for one of the qubits and expectation of σ_{y} for its identical twin.

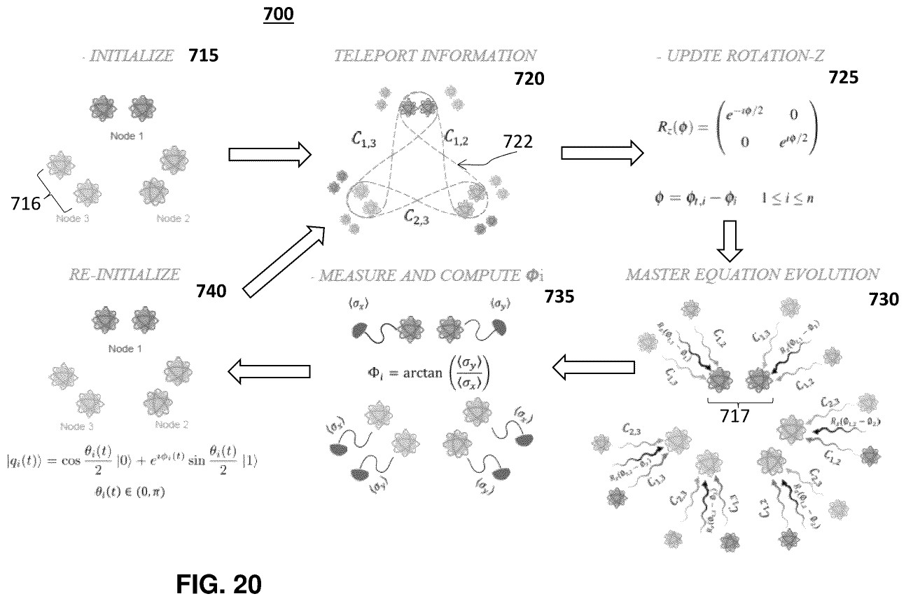

According to the quantum-secure embodiment, the iterative processing steps of FIG. 4 is modified as shown in the conceptual flow chart 700 of FIG. 20 as including, at step 715, at the QC at each DER node of the network, initializing a pair 716 of identical qubits as a point on the surface of the first quarter of the Bloch Sphere, i.e., 0<ϕᵢ(0)<π/2 and 0<θᵢ(t)<π, e.g., using equation 24) as follows:

$$\begin{matrix}a . & \\ \vert {q}_{i} ( t ) = cos \frac{π}{4} \vert 0 + {e}^{{ιϕ}_{i} ( t )} sin \frac{π}{4} \vert 1 , t ∈ \{ 0 , 1 , 2 , ... \} , & ( 24 )\end{matrix}$$

for each adjacent node. Then, at step 720, the QC transmits quantum information throughout the network such that each quantum node receives a pair of identical qubits from each one of its adjacent nodes. As shown at 720, FIG. 20, the three pairs of qubits interact through swapping operators C_{1,2}, C_{2,3} and C_{1,3}, forming a connected interaction graph 722. Then at step 725, at each node, the quantum system performs updating the rotation-Z (R_{z}(ϕ)) operator's argument according to equation 7) based on the pinner (ϕt,i) by selecting ϕ=ϕ_{t,i} −ϕᵢ where ϕᵢ is the current time step value of the phase angle. Further, at 730, the quantum system performs evolving the master equation for one time step St by means of the swapping and rotation-Z operators. For example, for each qubit of a first pair of qubits 717 prepared at a DER Node 1, the quantum circuit performs swapping operations based upon an underlying interaction graph (not shown) for the quantum network using swapping operator C_{1,2} associated with DER Node 1 and Node 2 and swapping operator C_{1,3} associated with DER Node 1 and Node 3 are used to drive the network to synchronization according to the quantum master equation. Then at 735 there is measured for each qubit pair, the expectation value of the σₓ operator for one of the qubits and σ_{y} for its identical twin. Repeating this multiple times and averaging gives the rᵢ sinθᵢ cos ϕᵢ and rᵢ sinθᵢ sin ϕᵢ, respectively. On classical hardware at each node, at step 735, FIG. 7, there is further computed arctan

$$( \frac{{σ}_{{y}^{}}}{{σ}_{{x}^{}}} )$$

to obtain the phase angle ϕᵢ. Finally, at 740 there is performed the re-initializing the state of each qubit pair at each quantum node and based on the measurement outcomes at step 735. The process repeats by returning to step 720 where the QC transmits updated quantum information, as updated (re-initialized) qubit pairs throughout the network such that each quantum node receives the revised updated pair of identical qubits from each one of its adjacent nodes and the process steps repeats until convergence (i.e., synchronization) of the network is achieved.

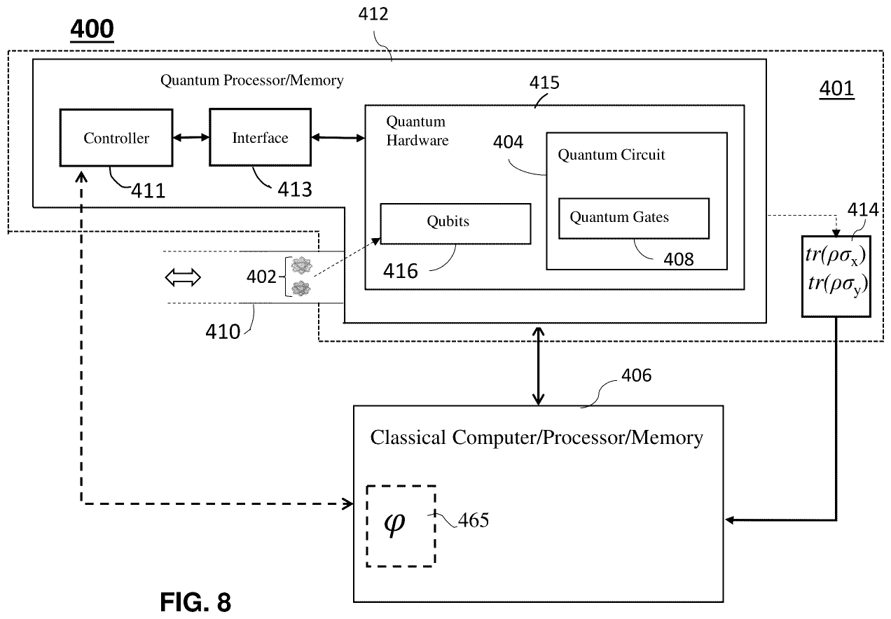

FIG. 8 is a block diagram illustrating an example computing environment 400 employed at a DER for quantum-secure distributed microgrid control in an embodiment. Computing environment 400 can be a hybrid computing system including a combination of one or more quantum computers, quantum systems, and/or and classical computers. In an embodiment shown in FIG. 8, computing environment 400 can be a hybrid computing system include a quantum system 401 having a quantum processor 412 and a classical computer 406. The quantum system 401 and classical computer 406 can be configured to be in communication via one or more of wired connections and wireless connections (e.g., a wireless network). Quantum computer 401 can include a quantum chipset that includes various hardware components for processing data encoded in qubits. The quantum chipset can be a quantum computing core surrounded by an infrastructure to shield the quantum chipset from sources of electromagnetic noise, mechanical vibration, heat, and other sources of noise, which tend to degrade performance. Classical computer 406 can be electronically integrated, via any suitable wired and/or wireless electronic connection, with quantum computer 401.

In the example shown in FIG. 8, quantum system 401 can be any suitable set of components capable of performing quantum operations on a physical system. A quantum operation can be, for example, a quantum gate operation that manipulate qubits to interact with one another in accordance with the quantum gate operation. In the example embodiment depicted in FIG. 8, quantum computing system 401 can include a quantum processer 412 having a controller 411, an interface 413, and quantum hardware 415. In some embodiments, all or part of each of controller 451, interface 413, and quantum hardware 415 can be located in a cryogenic environment to aid in the performance of the quantum operations. Quantum hardware 415 may be any hardware capable of using quantum states to process information. Such hardware may include a plurality of qubits 416, and mechanisms to couple/entangle qubits 416, in order to process information using the quantum states. A qubit can be implemented as a physical device. Examples of physical implementation of a qubit can include, but not limited to, a superconducting qubit, a trapped ion qubit, and/or others. Qubits 416 may include, but are not limited to, charge qubits, flux qubits, phase qubits, spin qubits, and trapped ion qubits. Quantum hardware 415 can include a set of quantum gates 408, where quantum gates 418 can be configured to perform quantum logic operations on qubits 416. Quantum gates 408 can include one or more single-qubit gates, two-qubit gates, and/or other multi-qubit gates.

Non-limiting examples of quantum gates 408, implemented on the quantum circuit 404 (e.g., using devices) can include Hadamard (or H) gates, controlled gates, and phase gates. The Hadamard gate acts on a single qubit and maps the basis state |0> to (|0>+|1>)/\sqrt{2} and the basis state |1> to (|0>−|1>)/\sqrt{2}. A phase gate (or S or its adjoint St) acts on a single qubit and may alter the phase of one basis state of the qubit while leaving the other basis state unchanged. A controlled gate may act on two or more qubits, where one or more of the qubits provide a control for an operation. Other gates are provided for turning the master equation into a quantum circuit.

As an example, to obtain the X, Y and [symbol] components of the qubit (on the Bloch sphere), e.g., found through measuring the [symbol] basis of the corresponding circuits, [symbol] , H(Hadamard gate) and S^{†} are defined as follows:

$$Z = ( \begin{matrix}1 & 0 \\ 0 & - 1\end{matrix} ) , H = \frac{1}{\sqrt{2}} ( \begin{matrix}1 & 1 \\ 1 & - 1\end{matrix} ) , {S}^{†} = ( \begin{matrix}1 & 0 \\ 0 & - ι\end{matrix} ) . \qquad a .$$

The [symbol] gate is used to perform measurement in the standard basis, e.g., z-basis or computational basis. The Z gate can implement any kind of measurement when combined with gates.].

In the quantum computing system 401, the quantum computing processor 412 can include or can construct one or more quantum circuits for performing quantum computations, for example, by applying various quantum gates 408 or operations on one or more qubits 416 or qubit states to result in quantum states of the qubits. For example, a quantum circuit can include a sequence of quantum gates, measurements, and other operations, with initialization of qubits to some values. In accordance with embodiments herein, qubits 416 include qubit(s) 402 received from adjacent node DER node over a secure quantum channel, e.g., optic-fiber cable 410, the qubits transported qubits having been encoded into quantum information representing the quantum state of a neighboring DER.

Referring to FIG. 8, the quantum circuit 404 in one or more embodiments can include a sequence of operations of quantum gates 408 on qubits 416, the quantum gates being configurable to simulate the time evolution of a quantum system represented by the master Lindblad equation for controlling DER operations, particularly, by updating the state of qubits at each of a plurality of nodes for providing real time control of power generated.

The input to the quantum circuit 404 can include one or more qubits 416, in addition to qubits 402 each received over a quantum channel 410. Each received qubit 402 represents the quantum state of a neighboring DER, particularly the dynamic of the phase angle ϕᵢ at the neighboring DERᵢ used for synchronization control of the microgrid network. The output of the quantum circuit 404 can include the expectation values 414 of the Pauli operators σₓ and σ_{y} as the observers at the node, i.e., tr(ρσₓ) and tr(ρσ_{y}), respectively. These values 414 are obtained at each time step of a series of time steps as outputs of the evolution of the master Lindblad equation. The output values 414 are received by classical computer 406 and used by the classical computer to compute the phase angle ϕᵢ for use in computing a secondary control variable for the DERᵢ and guarantee synchronization amongst all networked microgrids. To be described in further detail, the quantum circuit 404 implements quantum primitives or gates that map to the Pauli spin operators.

Controller 411 can be any combination of digital computing devices capable of performing a quantum computation, such as executing a quantum circuit 404, in combination with interface 413. Such digital computing devices may include digital processors and memory for storing and executing quantum commands using interface 413. Additionally, such digital computing devices may include devices having communication protocols for receiving such commands and sending results of the performed quantum computations to a classical computer 406. Additionally, the digital computing devices may include communications interfaces with interface 413. In one embodiment, controller 411 can be configured to receive classical instructions (e.g., from classical computer 406) and convert the classical instructions into commands (e.g., command signals) for interface 413. Command signals being provided by controller 411 to interface 413 can be, for example, digital signals indicating which quantum gates among quantum gates 408 needs to be applied to qubits 416 to perform a specific function (e.g., the master Lindblad equation evolution to obtain the dynamic of the phase angle for a DER as described herein). Interface 413 can be configured to convert these digital signals into analog signals (e.g., analog pulses such as microwave pulses) that can be used for applying quantum gates on qubits 416 to manipulate interactions between qubits 416.

Interface 413 can be a classical-quantum interface including a combination of devices capable of receiving commands from controller 411 and converting the commands into quantum operations for implementing quantum hardware 415. In one embodiment, interface 413 can convert the commands from controller 411 into drive signals that can drive or manipulate qubits 416, and/or apply quantum gates 408 on qubits 416. Additionally, interface 413 can be configured to convert signals received from quantum hardware 415 into digital signals capable of processing and transmitting by controller 411 (e.g., to classical computer 406). Devices included in interface 413 can include, but are not limited to, digital-to-analog converters, analog-to-digital converters, waveform generators, attenuators, amplifiers, optical fibers, lasers, and filters. Interface 413 can further include circuit components configured to measure a basis of the plurality of qubits following the implementation of quantum gates 408, where the measurement that will yield a classical bit result. For example, a basis of |ψ [symbol] corresponds to classical bit zero, and a basis of |1 [symbol] corresponds to classical bit one. Each measurement performed by interface 413 can be read out to a device, such as classical computer 406, connected to the quantum computing processor 412. A plurality of measurement results provided by interface 413 can result in a probabilistic outcome. In an embodiment, the qubit states output by quantum circuit 404 need not be measured, but can used directly by another quantum circuit, or used as input directly to another quantum circuit implemented on the quantum hardware 415.

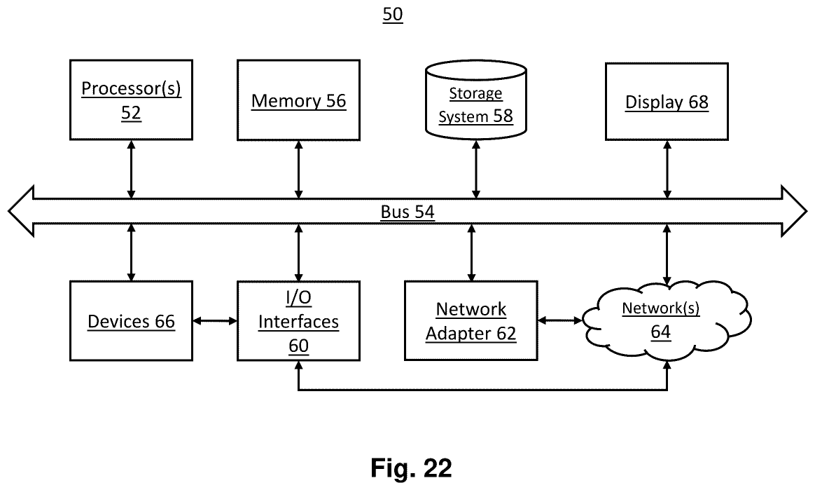

The quantum computing processor 412 may also be connected to a classical computing processor 406 (e.g., a non-quantum computing device), which can interface with the quantum computing processor 452 and perform various pre-processing and/or post-processing tasks associated with the quantum computing performed on the quantum computing processor 452. For example, the classical computing processor 406 may include or more hardware processor components, for example, including components such as programmable logic devices, microcontrollers, memory devices, and/or other hardware components, which may be configured to perform respective tasks described in the present disclosure. Coupled memory devices may be configured to selectively store instructions executable by one or more hardware processors. For example, a hardware processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities. The processor may execute computer instructions stored in the memory or received from another computer device or medium. Components of classical computer 466 are also described in more detail below with reference to FIG. 22. In an example system, classical computer 406 can be a laptop computer, a desktop computer, a vehicle-integrated computer, a smart mobile device, a tablet device, and/or any other suitable classical computing device.

### Quantum Distributed Frequency Control

In AC microgrids, a predominantly inductive network naturally decouples the load sharing process; the reactive power regulator must handle the reactive load sharing by adjusting voltage magnitude while the active power regulator would handle the active load sharing through adjusting the frequency. A common approach for inverter interfaced DER is to connect the power electronic inverter (e.g., VSC) with an LC filter. Therefore, the predominantly inductive line is either from the natural line/cable characteristics or implemented with virtual impedance. The locally deployed LC filter in each DER makes the output impedance inductive dominant, then the power sharing control laws that allow the active power to be shared based on DER unit's rated capacities according to the droop setting, can be written according to equation 25) as follows:

$$\begin{matrix}i & \\ {ω}_{i} = {ω}^{*} - {n}_{i} {P}_{i} . & ( 25 )\end{matrix}$$

As discussed, the problem of distributed frequency control and power sharing would take a form such as Eq. (1) where ϕᵢ as the secondary controller is a synchronization rule consisting of pinning terms and coupling mechanism and is a function of its current value, Pᵢ, and its neighbors' values Φⱼ's. Looking at Eq. (16), it can be seen that there are pinning terms, produced by the rotation-Z operators and coupling mechanism, produced by swapping operators. Therefore, in order to apply the QDC, there is defined the target for equation (16) which is done through scaling nᵢPᵢ. Here, vᵢPᵢ is called the power sharing signal. Specifically, vᵢPᵢ is scaled to be restricted to in the range (0, π/2); thus, the methods select k such that

$$k < \frac{π / 2}{max ( {n}_{i} {P}_{i} )}$$

so that, knᵢPᵢ is ready to be incorporated into the argument of the rotation-Z operator at node i and then the process follows the steps explained in FIG. 4. Hence, the QDC for AC microgrids is formulated according to equation 26) as follows

$${ω}_{i} = {ω}^{*} - {n}_{i} {P}_{i} + \frac{{ϕ}_{i}}{k} , \qquad ( 26 )$$

$${\dot{ϕ}}_{i} = sin ( {kn}_{i} {P}_{i} - {ϕ}_{i} ) + {\sum }_{j = 1}^{n} {a}_{i , j} sin ( {ϕ}_{j} - {ϕ}_{i} ) ,$$

where ϕᵢ/k is the secondary control variable. In the case of quantum-secure distributed microgrid control, the dynamic of ϕᵢ of equation 26) becomes:

$${\dot{ϕ}}_{i} = sin ( {kn}_{i} {P}_{i} - {ϕ}_{i} ) + {\sum }_{j = 1}^{n} {a}_{i , j}^{′} sin ( {ϕ}_{j} - {ϕ}_{i} )$$

where the scaled power sharing signal, sin(knᵢPᵢ−ϕᵢ) is the pinning term that forces the phase ϕᵢ at the node to stick at the value knᵢPᵢ=ϕ_{t,i} and is scaled to be restricted to (0, π/2) through selecting k such that

$$k < \frac{π / 2}{max ( {n}_{i} {P}_{i} )} i .$$

The coupling mechanism term

$${\sum }_{j = 1}^{n} {a}_{i , j}^{′} sin ( {ϕ}_{j} - {ϕ}_{i} )$$

of modified equation (16) synchronizes the entire system and all the nodes to the pinner ϕ_{t,i} exponentially fast.

In a typical AC microgrid with distributed line impedances, since the susceptance of line impedance is usually much larger than its conductance, and also due to the small angle difference between each bus voltage, the active power and reactive power are decoupled and the output active power of each DER can be expressed according to equation 27) as follows:

$$a . {P}_{i} = {\sum }_{p = 1}^{n} {E}_{i} {E}_{p} \vert {Y}_{i , p} \vert sin ( {δ}_{i} - {δ}_{p} ) = {\sum }_{p = 1}^{n} {g}_{i , p} sin ( {δ}_{i} - {δ}_{p} ) \qquad ( 27 )$$

where Eᵢ is the nodal voltage magnitudes Eᵢ>0, −Y_{i,p} is the admittance of the line between DER ᵢ and DERₚ and δᵢ is the voltage phase angle and its dynamic characteristic is \dot{δ}ᵢ=ωᵢ −ω*=ϕᵢ/k−nᵢPᵢ.

From equation (27), the physical power network is treated as a connected network whose entries of its adjacency matrix are g_{i,p}=EᵢEₚ |Y_{i,p} | and hence, considering (26), it can be readily obtained that, the coupling of the network of quantum distributed controllers and the physical microgrid is the coupling of a forced Kuramoto model with a Kuramoto model (FIG. 2). At the steady state, the microgrid is assumed stable. Since the DERs' frequency must be equal, then ωᵢ=ωⱼ and thus nᵢPᵢ −ϕᵢ/k=nⱼPⱼ−ϕⱼ/k ∀/i,j. As shown before, ϕᵢ converges to the pinner as t→∞. Thus, nᵢPᵢ=ϕᵢ/k and nᵢPᵢ=nⱼPⱼ ∀i,j and ωᵢ converges to ω*.

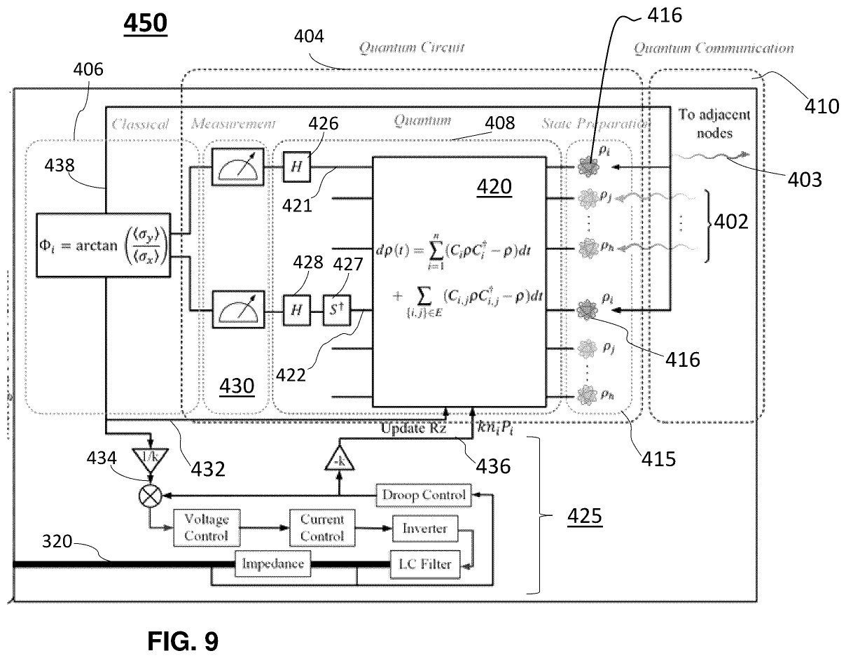

FIG. 9 is a more detailed depiction of the quantum distributed control (QDC) for the case of an AC microgrid network and particularly processing 450 at a DER node i (DERᵢ) implementing primary controller 425. As shown in FIG. 9, qubits 416 are prepared at the quantum state ρ reparation hardware 415 to encode system information (density matrix ρᵢ) at the DERᵢ node used for quantum distributed microgrid control. Similarly prepared for quantum gate processing are received qubits 402, each received qubit encoding state information ρₕ . . . ρₙ corresponding to adjacent DER nodes from respective quantum devices at the adjacent DER nodes over quantum communications channel 410. A qubit is further prepared with state information ρᵢ at the DERᵢ node for communication 403 to other adjacent DER nodes over quantum communications channel 410. At DERᵢ node, quantum circuit 404 captures and prepares the encoded qubits for processing according to a quantum algorithm. In an embodiment, quantum gates 408 are configured to implement a quantum algorithm 420 that evolves open quantum dynamics on quantum computing devices. One exemplary and non-limiting quantum algorithms used for evolving open quantum dynamics is described in the reference to [symbol] ixuan Hu, et al. entitled A Quantum Algorithm for Evolving Open Quantum Dynamics on Quantum Computing Devices (Scientific Reports (2020) 10:3301) incorporated by reference herein., and in the reference to [symbol] ixuan Hu, et al. entitled A General Quantum Algorithm for Open Quantum Dynamics Demonstrated with the Fenna-Matthews-Olson Complex (Quantum revised 24 May 2022 (V3)) incorporated by reference herein.

For quantum distributed microgrid control in particular, quantum gates 408 perform the time evolution of the master Lindblad equation to obtain the current state of the DER nodes in the network. That is, quantum gates 408 are configured as a synchronization protocol implementing the time evolution of the system's density matrix in accordance with the representation of equation 14). The time evolution processing at quantum circuit 404 generates a first output qubit 421 that is processed by applying a Hadamard gate 426 that maps to a Pauli operator σₓ or matrix (as an observable). Further, the time evolution processing at quantum circuit 404 generates a second output qubit 422 qubit that is processed by first applying an (conjugate-transpose)S-gate 427 and then applying a Hadamard gate 428 that maps to a Pauli operator ay or matrix (as an observable). Measurement circuitry 430 performs a quantum measurement on the processed qubits 421, 422 to obtain values for computing the dynamic of the phase angle at the node DERᵢ.

Measurement circuitry 430 can include circuit components configured to measure a basis of qubits, where the basis is a measurement that will yield a classical bit result. Each measurement performed by measurement circuit 430 can be read out to a device (e.g., a classical computer 406) connected to quantum computing system 401. For example, in view of FIG. 8, interface 413 can provide measurement results from a measurement circuit to classical computer 406, via controller 411. Classical computer 406 can store the measurement results in classical registers (not shown).

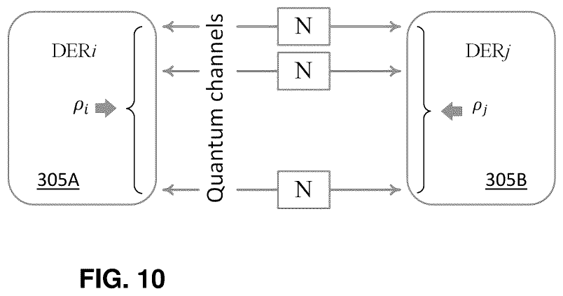

A plurality of measurement results provided by measurement circuit 430 can result in a probabilistic outcome. As the measurement of a quantum state is probabilistic, the system repeats the steps multiple times (in quantum time) such that an average of the outputs is obtained. For example, in an embodiment, FIG. 10 depicts two adjacent DER nodes: first DERᵢ node 305A encoding its quantum state information ρᵢ and a second node DERⱼ node 305B encoding its quantum state information ρⱼ and that exchange qubits representing these quantum states multiple times over communication channel 410. To obtain values for computing the dynamic of the phase angle at a node 305A, 305B, the qubits are exchanged for multiple (i.e., N) times and the applied quantum algorithm is repeated for N times to obtain the expectation value of the Pauli operators σₓ and σ_{y} as the observers at the node each time, which values are averaged to obtain the dynamic of the phase angle Øᵢ. Returning back to FIG. 9, classical computer 406 processes the original qubits N times to obtain N measurement results of the quantum circuit processing of output qubits 421, 422. These N measurement outcome results are averaged to obtain respective [symbol] σy [symbol] and [symbol] σx [symbol] values used to calculate the current value of the phase angle ϕᵢ according to: ϕᵢ=arctan

$$( \frac{〈 {σ}_{y} 〉}{〈 σ x 〉} ) .$$

Alternatively, classical computer can compute the current value of the phase angle ϕᵢ by computing values arccos [symbol] σₓ [symbol] or arcsin [symbol] σ_{y} [symbol] .

As shown in FIG. 9, in each time step of the time evolution for a density matrix, the current value of the phase angle ϕᵢ 432 is fed back to the quantum circuit 404 to update the rotation-Z (R_{z}(ϕ))operator's argument in the evolving algorithm at node i. The value of phase angle ϕᵢ is additionally multiplied by the value 1/k to obtain the secondary control variable 434 which is used for synchronization control (consisting of pinning term and coupling mechanism). The scale value-k is also multiplied to the power sharing signal nᵢPᵢ to obtain knᵢPᵢ signal 436 that is also input back to the quantum circuit for power sharing control. The knᵢPᵢ signal 436 is incorporated in the argument of the rotation-Z operator used in the algorithm 420 at node i.

In accordance with the method of FIG. 4, using the updated phase angle Pᵢ computed for the node at the current time step, the process reinitializes the quantum state of the qubits 416 of the DER node; according to equation 3), teleports the updated state information to adjacent nodes throughout the network and inputs the updated quantum qubit information back into the quantum circuit for evolving the master Lindblad equation in a further time step.

### Numerical Example

A second example of the quantum-secure system employing qubits for microgrid control illustrates that, in addition to synchronization, how choosing random variables for θᵢ results in an unprecedentedly secured distributed control framework. Considering a network composed of three quantum nodes as shown in FIG. 20 with the following initial states:

$$i . \vert {q}_{1} 〉 = cos \frac{1.96}{2} \vert 0 〉 = + sin \frac{1.96}{2} \vert 1 〉 = ,$$

$$ii . \vert {q}_{2} 〉 == cos \frac{1.46}{2} \vert 0 〉 = + {e}^{\frac{π}{θ} ι} sin \frac{1.46}{2} \vert 1 〉 ,$$

$$iii . \vert {q}_{3} 〉 = cos \frac{2.07}{2} \vert 0 〉 + {e}^{\frac{π}{2} ι} sin \frac{2.07}{2} \vert 1 〉 .$$

Here, the target is

$${ϕ}^{*} = \frac{π}{3} .$$

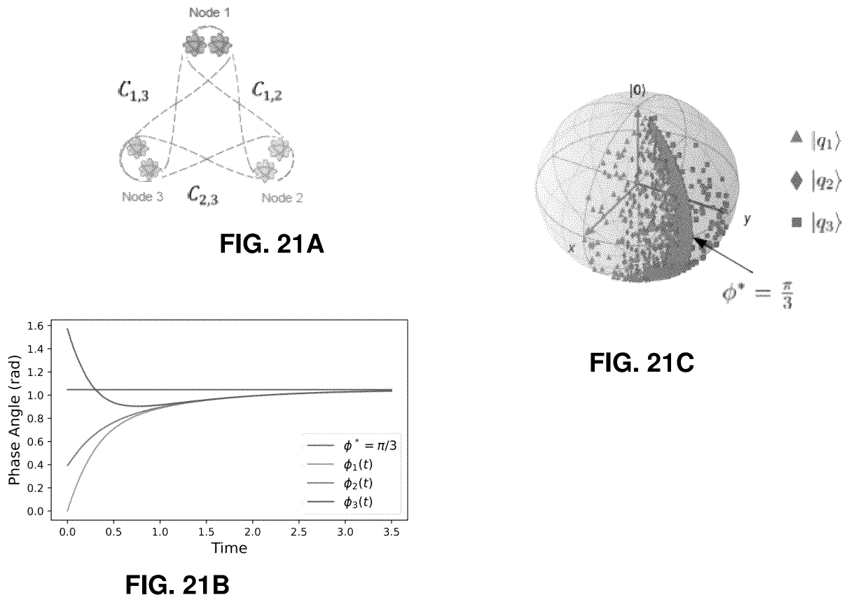

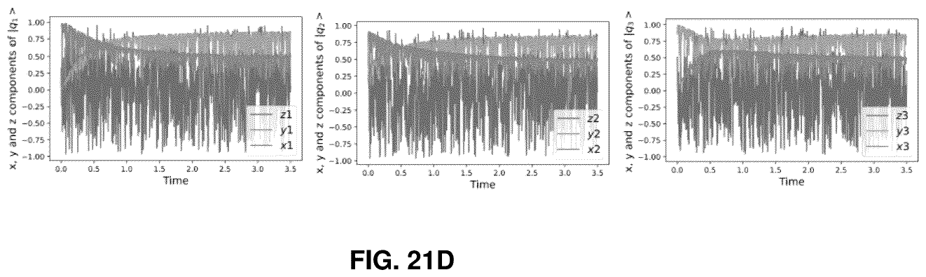

The three qubits interact through swapping operators C_{1,2}, C_{2,3} and C_{1,3}, forming a connected interaction graph as shown in FIG. 21A. Considering the state of the whole quantum network as ρ=|q₁q₂q₃q₁ q₂q₃ [symbol] . As an illustrative example, the swapping operator C_{1,2} would be as follows:

$$i . {C}_{1 , 2} = ( \begin{matrix}1 & 0 & 0 & 0 \\ 0 & 0 & 1 & 0 \\ 0 & 1 & 0 & 0 \\ 0 & 0 & 0 & 1\end{matrix} ) ⊗ ( \begin{matrix}1 & 0 \\ 0 & 1\end{matrix} )$$

such that,

$$ii . {C}_{1 , 2} \vert {q}_{1} ( t ) {q}_{2} ( t ) {q}_{3} ( t ) 〉 〈 {q}_{1} ( t ) {q}_{2} ( t ) {q}_{3} ( t ) \vert {C}_{1 , 2}^{†} - \vert {q}_{2} ( t ) {q}_{1} ( t ) {q}_{3} ( t ) 〉 〈 {q}_{2} ( t ) {q}_{1} ( t ) {q}_{3} ( t ) \vert = {[ 0 ]}_{8 \times 8}$$

The trajectories of ϕ₁, ϕ₂ and ϕ₃, i.e. ϕ angles of |q₁ [symbol] , |q₂ [symbol] and |q₃ [symbol] , respectively, are sketched in FIG. 21B utilizing the Python-based open source software QuTiP. As illustrated in FIG. 21B, all the three phase angles converge to ϕ*. Therefore, the final state of each quantum node is the state

$${[ cos \frac{{θ}_{i} ( t )}{2} , {e}^{\frac{π}{3} ι} sin \frac{{θ}_{i} ( t )}{2} ]}^{T}$$

where, 0<θᵢ(t)<π is a random value. FIG. 21C depicts the representation of the states of the quantum nodes on the Bloch sphere along time. As depicted in FIG. 21D, even if an eavesdropper is able to measure the x, y and z components of the exchanged qubits, the measurement outcomes are random values which do not reveal meaningful information. Thus, security is significantly enhanced by using superposition of qubits when the angle θ is randomized. For example, given a qubit initialized as follows:

$$a . \vert q 〉 = cos \frac{θ}{4} \vert 0 〉 + {e}^{\frac{π}{6} ι} sin \frac{θ}{4} \vert 1 〉 ,$$

where θ∈(0, π) can result in [symbol] σₓ [symbol] ≠cos ϕ, and hence, the probabilities of finding the qubit in 0/1 basis do not give information about the X component, and consequently the encoded information.

### Quantum Distributed Voltage Control for DC Microgrids

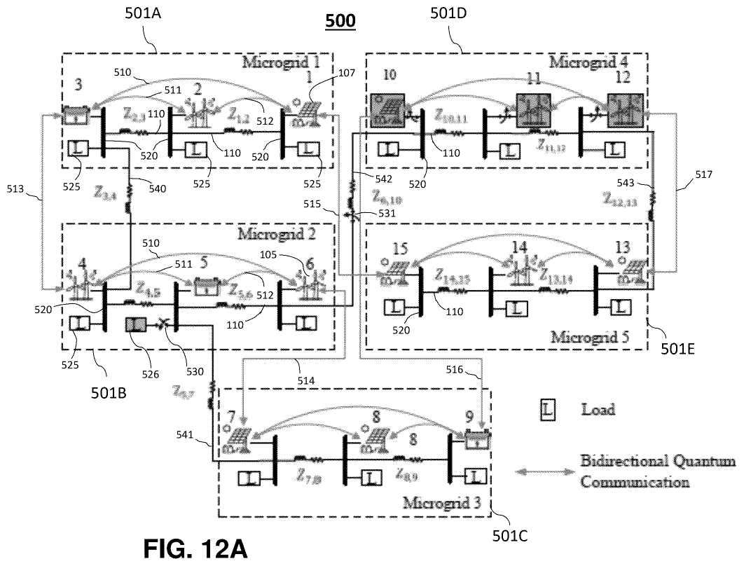

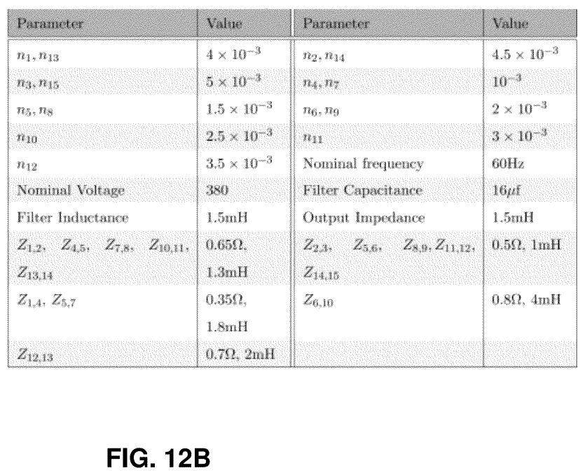

In DC microgrids, droop control function is mainly utilized to provide decentralized power sharing. It generates the voltage reference Vᵢ^{ref} according to equation 28) as follows:

$$i . {V}_{i}^{ref} = {V}^{*} - {d}_{i} {I}_{i} \qquad ( 28 )$$

where V* is the nominal dc voltage, dᵢ is the current droop gain, Iᵢ is the output current of node DER. FIG. 12A depicts a DC microgrid 600 according to an example embodiment and FIG. 12B depicts the parameters used in the QDC control. In FIG. 12A, DC microgrid 600 includes a plurality of DER's, e.g., DERs 105, 107, etc. with each respective DER supplying generated DC power to a DC power bus 620 via a respective dc power bus or link 603 through a corresponding DC/DC signal boost circuit 605. Each respective connected dc power link 603 is depicted as an impedance having resistive, capacitive and inductive components. FIG. 12B depicts the parameters used for distributed quantum control of power to satisfy real-time demands in the example dc microgrid 600 of FIG. 12A. For the example dc microgrid network of FIG. 12A, the nominal dc voltage is 200 V. Assuming nine (9) DERs in network 600, further parameters and corresponding example values shown in FIG. 12B, include but are not limited to: Filter inductance values Lᵢ (e.g., i=1, 2, . . . , 9), corresponding filter capacitance values Cᵢ, line resistance values Ri, the corresponding droop gain values mᵢ used for computing the power sharing signal, in addition to voltage loop value, current loop value and the value of the network load 625.

Considering the DC microgrid 600 of FIG. 12A, ignoring the inductance effect of lines, the DC bus voltage V_{b} can be determined according to equation 29) as follows:

$$i . {V}_{b} = {V}_{i}^{ref} - {R}_{i} {I}_{i} \qquad ( 29 )$$

It can be easily shown that, if the current droop gain dᵢ is set much larger than the line resistance Rᵢ, Iᵢ/Iⱼ ≈dᵢ/dⱼ and V_{b} ≈Vᵢ^{ref} ∀i, j. The larger dᵢ is chosen, the more accurate power sharing can be obtained, however, larger dᵢ may cause the dc bus voltage V_{b} to deviate more from the nominal value V*. Therefore, to attain both power sharing and precise voltage restoration, simultaneously, the method adds the QDC network including, at each each DER node: a quantum controller for distributed quantum control of power supplied by a DER to respond to real-time demands in the network and for controlling undirected communication of qubits between the QCs over quantum communication channels 610, 611, 612 within the dc microgrid 600. To equip the DC microgrid 600 with the QDC, the same implementation procedure for distributed frequency control and hence, the droop function of equation (28) is modified as shown in equation 30) as follow:

$$i . {V}_{i}^{ref} = {V}^{*} - {d}_{i} {I}_{i} + \frac{{ϕ}_{i}}{c} , \qquad ( 30 )$$

$${\dot{ϕ}}_{i} = sin ( {cd}_{i} {I}_{i} - {ϕ}_{i} ) + {\sum }_{j = 1}^{n} {a}_{i , j} sin ( {ϕ}_{j} - {ϕ}_{i} ) ,$$

which can be rewritten as

$$ii . {V}_{i}^{ref} = {V}^{*} - {m}_{i} {P}_{dc , i} + \frac{{ϕ}_{i}}{c} , \qquad ( 31 )$$

$${\dot{ϕ}}_{i} = sin ( {cm}_{i} {P}_{dc , i} - {ϕ}_{i} ) + {\sum }_{j = 1}^{n} {a}_{i , j} sin ( {ϕ}_{j} - {ϕ}_{i} ) ,$$

where P_{dc,i}=V_{b}Iᵢ and mᵢ is the power droop gain and ϕᵢ/c is the secondary control variable. Again, the method selects c such that

$$c < \frac{π / 2}{max ( {m}_{i} {P}_{dc , i} )} ,$$

so that, it is ready to be incorporated into the argument of the rotation-Z operator at node i and then the process follows the steps explained in FIG. 4. As can be seen, equation (31) has a similar form as the QDC for ac microgrids formulated according to equation (26). The first term in equation (31) is to drive the dc bus voltage V_{b} to the nominal value V* while the second term is to guarantee that ϕᵢ=ϕⱼ is satisfied, i.e., the current/power sharing is achieved which demonstrates that the QDC is also applicable to distributed voltage control in DC microgrids.

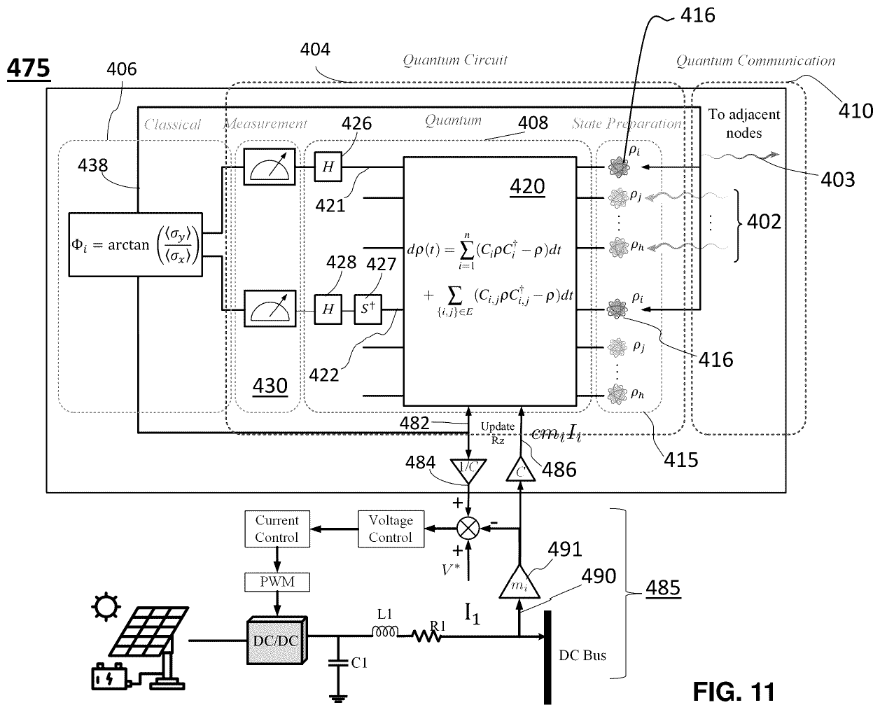

FIG. 11 is a more detailed depiction of the quantum distributed control (QDC) for the case of an DC microgrid network and particularly processing 475 at a DER node i (DERᵢ) implementing a different primary controller 485. The QDC processing circuitry 475 is identical to the QDC circuit 450 for the AC microgrid case as shown in FIG. 9. However, in the DC microgrid network, at DERᵢ node, in each time step of the time evolution for a density matrix, besides feeding back the current value of the phase angle ϕᵢ 482 to the quantum circuit 404 to update the rotation-Z (R_{z}(ϕ))operator's argument in the evolving algorithm at node i, the value of phase angle ϕᵢ is additionally multiplied by the scale value 1/c to obtain the secondary control variable 484 which is input to the primary controller 485 for synchronized power sharing in the DC microgrid network. The scale value c is also multiplied to the power sharing signal comprising a product of the droop gain mᵢ 491 and current DERᵢ node DC current Iᵢ 490 to obtain cmᵢIᵢ signal 486 that is also input back to the quantum circuit for power sharing control. The cmᵢIᵢ signal 486 is incorporated in the argument of the rotation-Z operator used in the algorithm 420 at node i.

### Verification on an AC Networked-Microgrid Case

The performance of the developed quantum distributed controller is tested on an example network of microgrids 500. FIG. 12A shows an example network of microgrids 500, i.e., five AC microgrids, 501A, 501B, . . . 501E, each microgrid having 3 DERs (quantum nodes), with microgrid 501A having three DERs or nodes connected by physical conductive busses or links 110, each DER node successively numbered DER 1-3. Each DER 1-3 is capable of sharing power over connected power links 110. In an embodiment herein, each DER includes an associated quantum distributed controller (QDC) of FIG. 9 that controls the sharing of power to meet requirements of synchronization and frequency control conduct bidirectional communication among the DER resources as depicted by a bi-directional arrow 510 depicting a quantum communication channel for exchange of qubits between QCs at node DER 1 and node DER 3 for the distributed quantum control of power supplied by a DER to an associated connected load, a bi-directional arrow 511 depicting a quantum communication channel for the exchange of qubits between QCs at node DER 2 and node DER 3 for the distributed quantum control of power supplied by a DER to an associated connected load, and a bi-directional arrow 512 depicting a quantum communication channel for the exchange of qubits between QCs at node DER 1 and node DER 2 for the distributed quantum control of power supplied by a DER to an associated connected load. Similarly, microgrid 501B includes three DER nodes successively labeled DER 4-6, each DER node having a quantum controller and processing for communicating over quantum communication channels as in microgrid 501A and each DER4-6 connected by conductive busses or links 110 for sharing power among those DER nodes over the links that connect to ac power busses 520 supplying power to connected loads, and microgrid 501C includes three DER nodes successively labeled DER 7-9, each DER node having a quantum controller and processing for communicating over quantum communication channels as in microgrid 501A, each DER node connected by conductive busses or links 110, and sharing power over the links connected to busses for supplying power to connected loads. Similarly, microgrid 501D includes three DER nodes successively labeled DER 10-12, each DER node having a quantum controller and processing for communicating over quantum communication channels as in microgrid 501A, each DER node connected by physical conductive busses or links 110, and each DER 10-12 sharing power over the links that connect to busses for supplying power to connected loads. As shown in FIG. 12A, microgrid 501E includes three DER nodes successively labeled DER 13-15, each DER node having a quantum controller and processing for communicating over quantum communication channels as in microgrid 501A, each DER node 13-15 connected by physical conductive busses or links 110, and sharing power among those DER nodes 13-15 over the links to ac power busses 520 supplying power to connected loads.

As shown in FIG. 12A, referring to microgrid 501A, each DER node 1-3 is connected to a respective ac power bus 520 for receiving power and for powering a reactive load L 525. As shown in FIG. 12A, a further physical conductive bus or link 540 connects the ac power bus 520 at node DER 3 of microgrid 501A to ac power bus 520 at node DER 4 of microgrid 501B to transfer power therebetween. As shown in FIG. 12A, a further conductive bus or link 541 connects the ac power bus 520 of node DER 5 of microgrid 501B to power bus 520 at node DER 7 of microgrid 501C to transfer electrical power therebetween. A further conductive bus or link 542 connects the ac power bus 520 at node DER 10 of microgrid 501D to ac power bus 520 at node DER 6 of microgrid 501B to transfer electrical power therebetween and a further conductive bus or link 543 connects the ac power bus 520 at node DER 12 of microgrid 501D to ac power bus 520 at node DER 13 of microgrid 501E to transfer power therebetween.

As shown in FIG. 12A, in accordance with the quantum distributed control method, quantum synchronization is achieved for a network of microdrids 500 using bidirectional quantum communication channels 510, 511, 512 within each microgrid for undirected quantum communications. Further bidirectional quantum communication channels for distributed quantum control of power supplied by a DER to respond to real-time demands in the network of microgrids 500 include: bi-directional arrow 513 depicting the quantum communication channel for the exchange of qubits between QCs at nodes DER 3 and DER 4, bi-directional arrow 514 depicting the quantum communication channel for the exchange of qubits between QCs at node DER 6 of microgrid 501B and node DER 7 of microgrid 501C, bi-directional arrow 515 depicting the quantum communication channel for the exchange of qubits between QCs at node DER 1 of microgrid 501A and node DER 15 of microgrid 501E; bi-directional arrow 516 depicting the quantum communication channel for the exchange of qubits between QCs at node DER 10 of microgrid 501D and node DER 9 of microgrid 501C; and bi-directional arrow 517 depicting the communication and the exchange of qubits between QCs at node DER 12 of microgrid 501D and node DER 13 of microgrid 501E for the real-time distributed quantum control of power supplied by a DER to satisfy network connected loads.

All other parameters used for distributed quantum control of power to satisfy real-time demands in the example network of microgrids 500 of FIG. 12A are shown in FIG. 12B. For the example microgrid network of FIG. 12A, the nominal voltage and frequency are 380 V and 60 Hz respectively, as shown in FIG. 12B. Further parameters and corresponding example values shown in FIG. 12B, include but are not limited to: parameter nᵢ (i=1, 2, . . . , 15) representing the droop gain used for computing the power sharing signal; the filter inductance, the impedances of the links connecting each DER node, e.g., impedances [symbol] _{1,2}, [symbol] _{2,3}, [symbol] _{4,5}, [symbol] _{5,6}, [symbol] _{7,8}, [symbol] _{8,9}, [symbol] _{10,11}, [symbol] _{11,12}, [symbol] _{13,14}, [symbol] _{14,15}, [symbol] _{3,4} between node DER 3 and node DER 4, impedance [symbol] _{5,7} between node DER 5 and node DER 7, impedance [symbol] _{6,10} between node DER 6 and node DER ₁₀, [symbol] _{12,13} between node DER 12 and node DER 13. Further parameter values include filter inductance, filter capacitance and output impedance.

Two example scenarios are examined. In the first scenario, the system is examined in the face of a step load change, where to show the controller performance, the load 526 at node DER 5 of microgrid 501B is attached and detached via a switch 530. In the second scenario, the QDC's feature of plug-and-play capability is verified by testing plug-and-play of DERs and microgrids. In the plug-and-play of DERs scenario, the highlighted nodes DER₁₀, DER₁₁ and DER₁₂ in Microgrid 501D are disconnected and reconnected again via a switch 531.

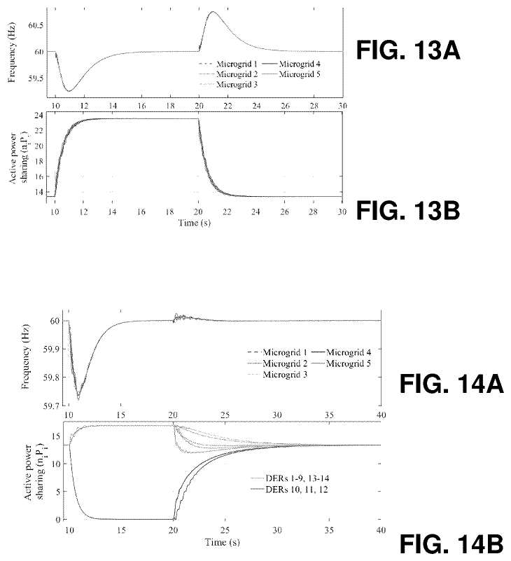

The performance of the quantum distributed controller for the example microgrid network 500 of FIG. 12A is now described. For example, FIGS. 13A and 13B depict the results of the performance of the QDC under a step load change applied to microgrid 2 at t=10s and particularly, the DER′ frequencies throughout the network after attaching and detaching the step load 526 using switch 530. As shown in FIG. 13A, frequency regulation is maintained throughout the step load change at t=10 sec; and as shown in FIG. 13B, active power (nᵢPᵢ) is accurately shared among the heterogeneous distributed generations (DGs) throughout the entire runtime.

FIGS. 14A and 14B depict the example results of the performance of the QDC under a first microgrid plug and play functionality where DERs 10, 11 and 12 are switched out of network and then switched back in the network. Due to the availability of renewable generators, a microgrid's physical and communication topologies can be time-varying. In this case, it is demonstrated that to support plug-and-play functionality, the QDC provides a robust secondary control framework that works effectively in spite of time-varying communication networks. Thus, this case verifies the QDC's feature of plug-and-play capability. This merit is investigated, by detaching DER₁₀ , DER₁₁ and DER₁₂ at t=10s and plugging them in again at t=20s. As depicted in FIGS. 14A, 14B after disconnection of the node DERs 10-12 at t=10 see, the power deficiency is reallocated among the remaining DERs 1-9, 13-14 and they manage to share the loads. Thus, as shown in FIGS. 14A, 14B, accurate active power sharing and frequency restoration are maintained during plug-and-play operation.

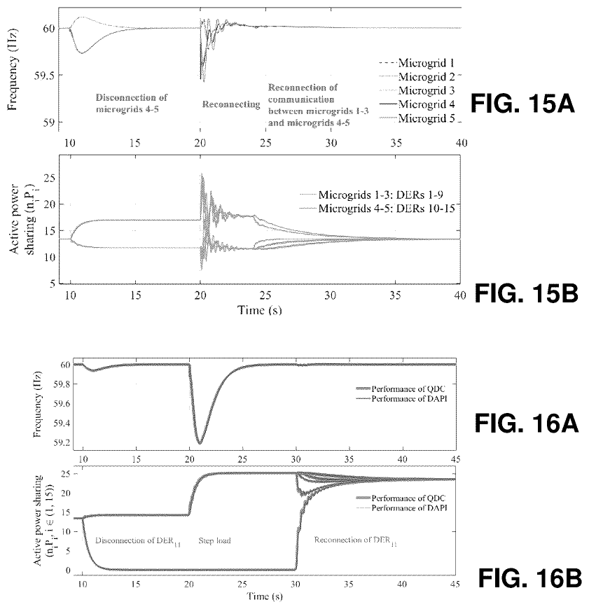

In a second plug-and-play scenario, both microgrids 501D and 501E are disconnected from microgrids 1, 2 and 3 at t=10s and reconnected again at t=20s using switch 531. Afterward, at t=24s, the quantum communication between microgrids 501A and 501E and microgrids 501C and 501D are reestablished. FIGS. 15A, 15B show how after disconnection of microgrids frequency is regulated in both microgrids 501A-501C and microgrids 501D-501E to the rated 60 Hz. Furthermore, after disconnection, the active power is shared among node DERs 1-9 and node DERs 10-15, and then among all the DERs after reconnection of microgrids 501D-501E, starting from t=24s. The reason of transient oscillations after reconnection at time t=20s is that, no presynchronization is implemented ahead of reconnection.

FIGS. 16A-16B depict a comparison between QDC and a conventional Distributed Averaging Proportional Integral (DAPI) controller in response to both step load and plug-and-play events in the example networked microgrids of FIG. 12A..In order to benchmark the QDC better, its performance is compared with the distributed-averaging PI (DAPI) controller (with the positive constant kᵢ=1). For both DAPI and QDC, the communication graph is the same as in FIGS. 12A, 12B. In this example case, DER₁ is unplugged at t=10s followed by the step load of 40 kw at t=20s, and then reconnected at t=30s. Results depicted in FIGS. 16A, 16B demonstrate that, regarding restoring time at the events of load disturbance and plug-and-play, both controllers have close performances. However, the embodiment of the QDC method herein enables encoding information into quantum states, directly sent over quantum channels among participating DERs, and thus allows microgrids to be profited from quantum communication advantages.

### Verification on a DC Microgrid Case Study

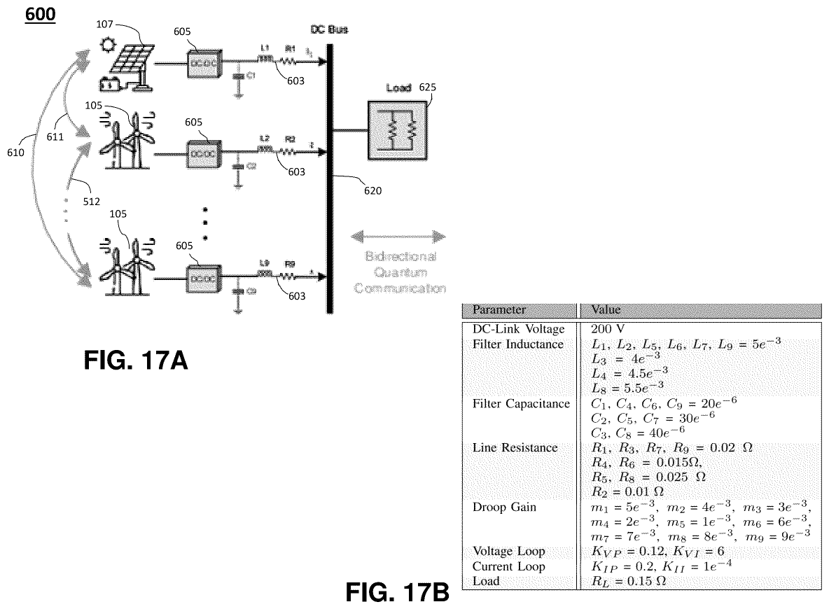

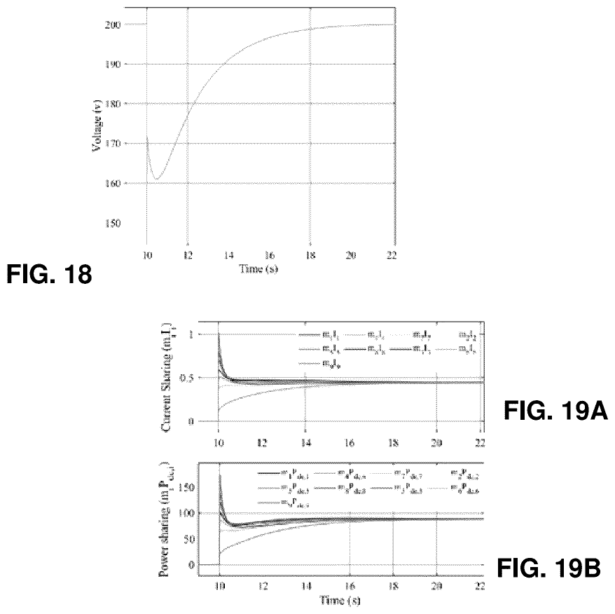

The universality of the QDC for handling the DC microgrid case is verified according to the results shown in FIGS. 18 and 19A-19B. This merit is investigated by equipping a nine (9) DER node DC microgrid network 600 shown in FIG. 17A (having relevant parameter values shown in FIG. 17B) with the QDC system 475 as shown in FIG. 11 and applying a step load of 267 kw at t=10s. FIG. 18 depicts example results of the voltage regulation after the step load disturbance in the example DC microgrid of FIG. 17A, where the DERs are regulated to converge to the requested DC link voltage of 200V. FIG. 19A depicts example results of the current sharing after the step load disturbance in the example DC microgrid of FIG. 17A and FIG. 19B depicts example results of the power sharing after the step load disturbance in the example DC microgrid of FIG. 17A.

As can be seen, voltage regulation is guaranteed throughout the step load disturbance and power/current is accurately shared among the heterogeneous DGs throughout the entire runtime.

FIG. 22 illustrates a schematic of an example computer or processing system 50 that can implement classical computing operations for quantum-secure distributed microgrid control in one embodiment. The computer system 50 is an example of a suitable processing system and is not intended to suggest any limitation as to the scope of use or functionality of embodiments of the methodology described herein. The computer system 50 shown may be operational with numerous other general-purpose or special purpose computing system environments or configurations. Examples of well-known computing systems, environments, and/or configurations that may be suitable for use with the processing system shown in FIGS. 9 and 11 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, supercomputers, quantum computing systems, hybrid systems including quantum computers and classical computers, and distributed cloud computing environments that include any of the above systems or devices, and the like. Classical computers among computer system 50 can execute classical computing processes by performing operations based on information encoded in bits.

The computer system 50 may be described in the general context of computer system executable instructions, such as program modules, being implemented by a computer system. Generally, program modules may include routines, programs, objects, components, logic, data structures, and so on that perform particular tasks or implement particular abstract data types. The computer system 50 may be practiced in distributed cloud computing environments where tasks are performed by remote processing devices that are linked through a communications network. In a distributed cloud computing environment, program modules may be located in both local and remote computer system storage media including memory storage devices.

The components of computer system 50 may include, but are not limited to, one or more processors or processing units 52, a system memory 56, a bus 54, storage system(s) 58, I/O interface(s) 60, network adapter(s) 62, network 64, devices 66, and display(s) 68. Bus 54 may couple various components of computer system 50. The processor 52 may include modules (e.g., programming modules) that performs the methods described herein. The modules among processor 52 may be programmed into the integrated circuits of the processor 52, or loaded from memory 56, storage device 58, or network 64 or combinations thereof. Processor 52 can be, for example, a microprocessor, a microcontroller, a processor core, a multicore processor, central processing unit (CPU) of computing devices such as a classical computer and/or quantum computers, and/or other types of computer processing element.

Bus 54 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Universal Serial Bus (USB), Video Electronics Standards Association (VESA) local bus, and Peripheral Component Interconnects (PCI) bus.

Computer system 50 may include a variety of computer system readable media. Such media may be any available media that is accessible by computer system, and it may include both volatile and non-volatile media, removable and non-removable media.

System memory 56 can include computer system readable media in the form of volatile memory, such as random access memory (RAM) and/or cache memory or others. Computer system may further include other removable/non-removable, volatile/non-volatile computer system storage media. By way of example, storage system 58 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 54 by one or more data media interfaces.

Computer system 50 may also communicate with one or more external devices 66 such as a keyboard, a pointing device, a display 68, network card, modem, etc. that enable a user to interact with computer system and/or that enable computer system 50 to communicate with one or more other computing devices. Devices 66 can be connected to components among computer system 50 via bus 54 and/or input/output (I/O) interfaces 60.

Computer system 50 can communicate with one or more networks 64 such as a local area network (LAN), a general wide area network (WAN), and/or a public network (e.g., the Internet) via network adapter 62 and/or I/O interfaces 60. Computer system 50 can communicate with networks 64 through wired connections (e.g., wires or cables connected to bus 54) or wireless connections (e.g., through network cards among I/O devices 60 and/or network adapter 62). Network adapter 62 can communicate with the other components of computer system 50 via bus 54. It should be understood that although not shown, other hardware and/or software components could be used in conjunction with computer system 50. Examples include, but are not limited to: field-programmable gate array (FPGA), system on chip (SoC), microcode, device drivers, redundant processing units, external disk drive arrays, RAID systems, tape drives, and data archival storage systems, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The described aspects and examples of the present disclosure are intended to be illustrative rather than restrictive, and are not intended to represent every aspect or example of the present disclosure. While the fundamental novel features of the disclosure as applied to various specific aspects thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or aspects of the disclosure may be incorporated in any other disclosed or described or suggested form or aspects as a general matter of design choice. Further, various modifications and variations can be made without departing from the spirit or scope of the disclosure as set forth in the following claims both literally and in equivalents recognized in law.

What is claimed is:

1. A system for distributed control of an electrical network, the network having a plurality of distributed energy resource nodes for providing power to a connected load, the system comprising:
a quantum processor associated with each distributed energy resource (DER) node, each quantum processor configured to:
prepare one or more qubits representing a quantum state associated with the power signals provided to the electrical network by the DER node;
receive one or more additional qubits input from one or more adjacent DER nodes, each one or more additional qubit representing a quantum state associated with the power signals provided to the electrical network by each adjacent DER node;
iteratively update, over time, a quantum state associated with said DER node by processing said one or more qubits and additional qubits received from adjacent nodes, and measuring, at each iteration, using a measurement device, one or more processed qubits to obtain a corresponding measured phase angle value associated with a state of power signals provided by said DER and said adjacent DER nodes;
generate, using a computing device, one or more control signals based on said obtained corresponding measured phase angle value; and
use, by the computing device, said control signals to control a characteristic of said power signals provided to the electrical network by the DER node.

2. The system of claim 1, further comprising:
a respective quantum communications channel connecting each respective adjacent DER node of the electrical network to the DER node, each quantum communications channel for enabling exchange of qubits between said DER node and each adjacent DER node of said electrical network at each iteration.

3. The system of claim 2, wherein the measuring one or more processed qubits to obtain a corresponding phase angle value comprises: performing, at each iteration, multiple measurements using the measurement device to obtain an averaged phase angle value.

4. The system of claim 2, wherein to iteratively update, over time, a quantum state of the associated DER node, said quantum processor configuring a quantum circuit to enforce a synchronization rule comprising a pinning component that forces the obtained phase angle at the DER node to a desired target phase angle.

5. The system of claim 4, wherein a desired target phase angle is a function of an injected power sharing signal comprising a measured power output value at the DER node multiplied by a scaling factor.

6. The system of claim 5, wherein to enforce the pinning component, said quantum circuit is configured with a rotation-Z operator to perform a single-qubit rotation upon each one or more qubits through obtained phase angle radians around the Z-axis of a Bloch sphere representation of the qubit.

7. The system of claim 6, wherein said synchronization rule further comprises a coupling mechanism component used to synchronize power signals provided by all the DERs nodes of the electrical network to a desired target active power value.

8. The system of claim 7, wherein to synchronize power signals using the coupling mechanism component, said quantum circuit is configured with swapping operators that specify interaction of qubits representing respective quantum states of two adjacent quantum nodes that exchange qubits, each swapping operator configured to exchange a state of two qubits from adjacent DER nodes.

9. The system of claim 8, wherein to synchronize power signals using the coupling mechanism component, said quantum circuit is further configured with one or more jump operators, each jump operator for processing a single qubit at the DER node and said quantum processor updating said jump operator based on the target phase angle and a each corresponding measured phase angle of the processed qubit.

10. The system of claim 9, wherein said jump operator is a function of the single-qubit rotation around the Z-axis by phase angle radians performed upon the corresponding qubit by said rotation-Z operator.

11. The system of claim 4, wherein the synchronization rule is derived from a master Lindblad differential equation describing the quantum state of said plurality of DER nodes, wherein to iteratively update, by said quantum processor, a quantum state of the DER node, the quantum circuit is further configured to evolve the master Lindblad differential equation operating on said one or more qubits of the DER node and additional received qubits from adjacent DERs as input at each iteration.

12. The system of claim 4, wherein, at each iteration, said quantum processor configured to re-initialize each said one or more qubits based on a most recent obtained phase angle value.

13. The system of claim 4, wherein each said one or more prepared qubits is initialized to comprise: a first phase angle ϕ value component used for encoding said quantum state information associated with said DER node, and a second phase angle θ value component, wherein at each iteration, said second phase angle θ being randomized to prevent theft of said quantum state information encoded in said first phase angle ϕ value.

14. A quantum distributed electrical network control system comprising:
a plurality of quantum computing nodes, each quantum node associated with a distributed energy resource (DER) producing energy in an electrical network;
a quantum processor associated with each quantum node for processing qubits; and
a quantum communications infrastructure comprising quantum channels connecting quantum processors at one or more quantum nodes, each quantum channel configured to enable an exchange of qubits between connected quantum processors;
wherein each quantum processor at a quantum node is configured to:
encode one or more qubits at the quantum node with quantum state information associated with power signals shared in the electrical network by the associated DER;
receive, over said quantum channels, one or more qubits from other adjacent quantum nodes sharing power signals in the electrical network by the adjacent DERs, each said received one or more qubits from adjacent quantum nodes encoded with quantum state information associated with shared power signals provided to the electrical network by the adjacent DER;
configure a quantum circuit at each node to simulate an open quantum system represented by a master equation;
process, using said configured quantum circuit at each node, each said encoded one or more qubits at the quantum node and said received one or more encoded qubits from other adjacent quantum nodes, to generate an output signal value representing a phase angle of the quantum state of the quantum node associated with the DER;
convert said phase angle value into a control signal; and
use the control signal to synchronize said power signals provided to the electrical network by each the DER.

15. The control system of claim 14, wherein the master equation is a master Lindblad differential equation describing the quantum state of said plurality of DER nodes.

16. The control system of claim 15, wherein the processing of each said encoded one or more qubits at the quantum node and said received one or more encoded qubits from other adjacent quantum nodes comprises:
iteratively updating, over time, using the quantum processor, a quantum state of the quantum node associated with said DER, and
measuring, at each iteration, using a measurement device, one or more processed qubits to obtain a corresponding measured phase angle value associated with a state of power signals provided by said DER and said adjacent DER nodes.

17. The control system of claim 16, wherein said electrical network is an alternating current (AC) electrical network, a characteristic of said power signals comprising a signal frequency, said iteratively updating ensuring a synchronization of the signal frequency of said power signals provided by each of the plurality of DERs in said AC electrical network based on a corresponding phase angle value obtained at each iteration.

18. The control system of claim 17, wherein said iteratively updating ensures a precise sharing of active power signals provided by each said plurality of DERs in said AC electrical network.

19. The control system of claim 16, wherein said electrical network is a direct current (DC) electrical network, a characteristic of said power signals comprising a voltage, said iteratively updating ensuring a voltage regulation of said power signals provided by each of the plurality of DERs in said DC electrical network.

20. A method for distributed control of an electrical network, the network having a plurality of distributed energy resource nodes for providing power to a connected load, the method comprising:
preparing using a quantum processor associated with each distributed energy resource (DER) node, one or more qubits representing a quantum state associated with the power signals provided to the electrical network by the DER node;
receiving, over a quantum communications channel, one or more additional qubits input from one or more adjacent DER nodes, each one or more additional qubit representing a quantum state associated with the power signals provided to the electrical network by each adjacent DER node;
iteratively updating, over time, using the quantum processor, a quantum state associated with said DER node by processing said one or more qubits and additional qubits received from adjacent nodes, and measuring, at each iteration, using a measurement device, one or more processed qubits to obtain a corresponding measured phase angle value associated with a state of power signals provided by said DER and said adjacent DER nodes;
generating, using a computing device, one or more control signals based on said obtained corresponding measured phase angle value; and
using, by the computing device, said control signals to control a characteristic of said power signals provided to the electrical network by the DER node.

21. The method of claim 20, further comprising:
exchanging, using said quantum processor, qubits between said DER node and each adjacent DER node of said electrical network over a quantum communications channel at each iteration.

22. The method of claim 21, wherein the measuring one or more processed qubits to obtain a corresponding phase angle value comprises:
performing, at each iteration, multiple measurements using the measurement device to obtain an averaged phase angle value.

23. The method of claim 21, wherein the iteratively updating, over time, a quantum state of the associated DER node, comprises: configuring, using said quantum processor, a quantum circuit to enforce a synchronization rule comprising a pinning component that forces the obtained phase angle at the DER node to a desired target phase angle.

24. The method of claim 23, wherein a desired target phase angle is a function of an injected power sharing signal comprising a measured power output value at the DER node multiplied by a scaling factor.

25. The method of claim 24, wherein to enforce the pinning component, said method comprises:
configuring, using said quantum processor, a quantum circuit with a rotation- [symbol] operator to perform a single-qubit rotation upon each one or more qubits through obtained phase angle radians around the Z-axis of a Bloch sphere representation of the qubit.

26. The method of claim 25, wherein said synchronization rule further comprises a coupling mechanism component used to synchronize power signals provided by all the DERs nodes of the electrical network to a desired target active power value.

27. The method of claim 26, wherein to synchronize power signals using the coupling mechanism component, said method further comprises:
configuring, using said quantum processor, said quantum circuit with swapping operators that specify interaction of qubits representing respective quantum states of two adjacent quantum nodes that exchange qubits, each swapping operator configured to exchange a state of two qubits from adjacent DER nodes.

28. The method of claim 27, wherein to synchronize power signals using the coupling mechanism component, said method further comprises:
configuring, using said quantum processor, said quantum circuit with one or more jump operators, each jump operator for processing a single qubit at the DER node; and
updating, using said quantum processor, said jump operator based on the target phase angle and each corresponding measured phase angle of the processed qubit.

29. The method of claim 28, wherein said jump operator is a function of the single-qubit rotation around the Z-axis by phase angle radians performed upon the corresponding qubit by said rotation-Z operator.

30. The method of claim 23, wherein the synchronization rule is derived from a master Lindblad differential equation describing the quantum state of said plurality of DER nodes, wherein to iteratively update a quantum state of the DER node, said method further comprises:
configuring, using said quantum processor, the quantum circuit to evolve the master Lindblad differential equation operating on said one or more qubits of the DER node and additional received qubits from adjacent DERs as input at each iteration.

31. The method of claim 23, further comprising: re-initializing, using said quantum processor, at each iteration, each said one or more qubits based on a most recent obtained phase angle value.

32. The method of claim 23, wherein each said one or more prepared qubits is initialized to comprise: a first phase angle ϕ value component used for encoding said quantum state information associated with said DER node, and a second phase angle θ value component, said method further comprising:
at each iteration, randomizing a value of said second phase angle θ to prevent theft of said quantum state information encoded in said first phase angle ϕ value.

33. A method for distributed control of an electrical network having a plurality of quantum computing nodes, each quantum node associated with a distributed energy resource (DER) producing energy in an electrical network, each quantum node having an associated quantum processor for processing qubits, and said electrical network having a quantum communications infrastructure comprising quantum channels connecting quantum processors at one or more quantum nodes, each quantum channel configured to enable an exchange of qubits between connected quantum processors, said method comprising;
encoding, at a quantum processor at each quantum node, one or more qubits at the quantum node with quantum state information associated with power signals shared in the electrical network by the associated DER;
receiving, over said quantum channels, one or more qubits from other adjacent quantum nodes sharing power signals in the electrical network by the adjacent DERs, each said received one or more qubits from adjacent quantum nodes encoded with quantum state information associated with shared power signals provided to the electrical network by the adjacent DER;
configuring, by the quantum processor, a quantum circuit at each node to simulate an open quantum system represented by a master equation;
processing, using said configured quantum circuit at each node, each said encoded one or more qubits at the quantum node and said received one or more encoded qubits from other adjacent quantum nodes, to generate an output signal value representing a phase angle of the quantum state of the quantum node associated with the DER;
converting, using a computer system, said phase angle value into a control signal; and
using the control signal to synchronize said power signals provided to the electrical network by each the DER.

34. The method of claim 33, wherein the master equation is a master Lindblad differential equation describing the quantum state of said plurality of DER nodes.

35. The method of claim 34, wherein the processing of each said encoded one or more qubits at the quantum node and said received one or more encoded qubits from other adjacent quantum nodes comprises:
iteratively updating, over time, using the quantum processor, a quantum state of the quantum node associated with said DER, and
measuring, at each iteration, using a measurement device, one or more processed qubits to obtain a corresponding measured phase angle value associated with a state of power signals provided by said DER and said adjacent DER nodes.

36. The method of claim 33, wherein said electrical network is an alternating current (AC) electrical network, a characteristic of said power signals comprising a signal frequency, said iteratively updating ensuring a synchronization of the signal frequency of said power signals provided by each of the plurality of DERs in said AC electrical network based on a corresponding phase angle value obtained at each iteration.

37. The method of claim 36, wherein said iteratively updating ensures a precise sharing of active power signals provided by each said plurality of DERs in said AC electrical network.

38. The method of claim 33, wherein said electrical network is a direct current (DC) electrical network, a characteristic of said power signals comprising a voltage, said iteratively updating ensuring a voltage regulation of said power signals provided by each of the plurality of DERs in said DC electrical network.
